(19) United States
(12) Patent Application Publication
(10) Pub. No.: US 2007/0198365 A1
(43) Pub. Date: Aug. 23, 2007

(54) Electronic trading post

(76) Inventors: Sanchayan Dutta, Palm Desert, CA (US); Karthik Ramaswamy, Naperville, IL (US); Nilesh Shah, Bloomington, IL (US); Shahab Sheikh Bahaei, San Francisco, CA (US)

Correspondence Address: PERKINS COIE LLP, P.O. BOX 2168, MENLO PARK, CA, 94026, US

(21) Appl. No.: 11/656,142

(22) Filed: Jan. 19, 2007

Related U.S. Application Data
(60) Provisional application No. 60/760,485, filed on Jan. 19, 2006.
(60) Provisional application No. 60/801,710, filed on May 18, 2006.

(51) Int. Cl. G06Q 30/00

(52) U.S. Cl. 705/26

(57) ABSTRACT

A method and system for on-line trading and selling, e.g., in an on-line auction, are disclosed. The system provides a polytopic market data (PMD) database for use in spotting fraudulent or suspicions items for sale or trade. The system may include a Sale-it-Now feature that uses historical price data and time-to-respond values to encourage bidding close price levels at or close to historical highs. The system may include a Pareto Sale feature for multiple agents, to identify groups of stable trading arrangements. The system may include Alerts for alerting buyers, sellers or traders in the system to selling, buying, or trading opportunities.

### CLAIM OF PRIORITY

This application claims the benefit of U.S. Provisional Application No. 60/760,485, filed Jan. 19, 2006 (Attorney Docket No.: 60239-8001.US00) and U.S. Provisional Application No. 60/801,710, filed May 18, 2006 (Attorney Docket No.: 60239-8002. US00) which are both incorporated herein in their entirety by reference.

### FIELD OF THE INVENTION

The present invention relates to an on-line auction system and methods for facilitating and promoting on-line exchange of goods.

### BACKGROUND OF THE INVENTION

E-commerce sites typically provide a role of listing agent. For example, users may visit a web site to find listings of goods for sale, and select one or more for purchase. These sites often make money by either selling the items that are on the list (e.g., the list may be a menu of items that a vendor controlling the site has for sale) or by charging potential sellers to list the items. Some sites even allow the listing of items for free, and obtain revenue in some other manner, such as by charging advertisers to place ads on the site. In any case, e-commerce sites of today often have a primary purpose of serving the role of a listing agent.

The foregoing examples of the related art and limitations related therewith are intended to be illustrative and not exclusive. Other limitations of the related art will become apparent to those of skill in the art upon a reading of the specification and a study of the drawings.

### SUMMARY OF THE INVENTION

The invention includes, in one aspect, a method for reducing the risk of having inferior or fraudulent items being offered and sold in an on-line auction system for selling or exchanging items of goods between sellers and buyers, comprising the steps of:

(a) for a given type or class of goods, constructing a polytopic representation for a group of known valid items of the given type or class, in which each of a number of attributes of the goods are plotted as a function of a common attribute, and the set of all attribute plots are assembled to form a composite polytopic figure,

(b) for a new test item within such type or class of goods, constructing a polytopic representation of the item,

(c) comparing the polytopic representation of the test item against the polytopic representation of the known valid goods, to determine if each of the test-item attributes falls within an acceptable attribute range for the known valid goods, and

(d) if the attribute properties of the test item are within the acceptable attribute ranges of the known valid goods, the item is accepted for sale or trade, and otherwise rejected.

The common attribute employed in step (a) may be the price of the goods, and other attributes of the goods that are plotted against price include at least three attributes selected from the group related to (i) the condition of the goods, (ii) features that contribute to the performance or utility of the goods, and (iii) features that contribute to buyer appeal.

The polytopic representations constructed in steps (a) and (b) may be formed by rotating each attribute plot about the common-attribute axis, to form a 3-D multi-faceted solid, and comparing step (c) may include visually comparing the two polytopic representation visually or using pattern recognition.

A test item accepted in step (d) may be added to the goods used in calculating a known valid polytopic representation of the goods in step (a).

Also disclosed is computer-readable code embedded in a machine-readable medium, operable to direct the operation of a computer for use in carrying out steps (a)-(d) in the above method.

Further disclosed is an on-line auction system for selling or exchanging items of goods between sellers and buyers, comprising

(a) a website,

(b) a database for storing, for each of at least some of the goods being offered or traded on the website, a polytopic representation for a group of known valid items of that good, in which each of a number of attributes of the goods are plotted as a function of a common attribute, and the set of all attribute plots are assembled to form a composite polytopic figure, and

(c) computational means for constructing such a polytopic representation of a test item within such type or class of goods,

wherein, by comparing the polytopic representation of the test item against the polytopic representation of the known valid goods of the same type, it can be determined whether the test-item attributes fall within an acceptable attribute ranges for known valid goods of that type.

In another general aspect, the invention includes a method for promoting sell-it-now (SIN) buyer-bidding activity in an on-line auction system in which a plurality of goods of a given type are available for sale, and a plurality of potential on-line buyers have been identified. The method includes the steps of

(a) ordering the goods into a plurality of price-range clusters,

(b) calculating time-to-react values for the goods in each cluster, based on the price of the goods,

(c) identifying potential buyers and amounts the buyers have indicated they might pay for goods of the given type,

(d) sending to a plurality of potential buyers, an offer for sale identifying the item(s) for sale, a quoted price related to the cluster price, time-to-react values, and optionally, historical information about the sale of similar goods in the quoted price range, where different potential buyers are sent different quoted prices and time-to-react values,

(e) recording the top “buy” bid from a potential buyer submitted within the indicated time-to-react,

(f) alerting the other potential buyers of the top bid, along with a given time-to-react, and

(g) repeating steps (e) and (f) until a final top bid is accepted.

Steps (d) through (g) may be repeated for remaining, unsold goods within the cluster.

The cluster prices may be disjoint, and the items in the clusters may be ranked for order of presentation to potential buyers as a function of cluster price and quantity of goods within a cluster.

The time to-react values may be calculated as the product of a factor that is calculated as an inverse function of (i) the total number of interested buyers and (ii) the difference between the offered price and a historical average and/or highest historical value for that type of goods, times the offered price.

Also disclosed is computer-readable code embedded in a machine-readable medium, operable to direct the operation of a computer for use in carrying out steps (a)-(g) of the above SIN method.

In still another general aspect, the invention includes a method for coordinating the trading of goods between multiple traders in an on-line trading system, comprising the steps of:

(a) identifying, for each such trader, the goods that trader has to offer and the goods the trader wishes to acquire,

(b) identifying the item similarity between those that are being offered and those that a trader wishes to acquire,

(c) identifying, from among all of the possible item exchanges between and among traders, (i) all stable transactions in which each trader gives and receives a comparable number of items, and (ii) the number of traders involved in each stable transaction, and

(d) for at least one of the stable transactions identified in step (c), presenting each trader with names of items that the trader will be exchanging in the transaction.

Step (c) of the method may include constructing a directed graph showing all traders as nodes and the possible items of trade between each pair of traders as connection between nodes, and identifying on the graph, all subgraphs in which each trader gives and receives a comparable number of items.

The stable transactions may be presented to the traders substantially in the order of total number of traders involved, or they may be presented substantially in the order of total number of items that may be traded in the transaction

After receiving acceptance or rejection of the proposed trade from the traders, it may confirmed whether the transaction is still a stable one, and if it is, completing the transaction between and among all of the consenting traders.

Also disclosed is computer-readable code embedded in a machine-readable medium, operable to direct the operation of a computer for use in carrying out steps (a)-(g) of the trading method above.

In still another aspect, the invention includes a method for alerting buyers, sellers, or traders in an on-line auction system to selling, buying, or trading opportunities. The method includes the steps of:

(a) storing information relating to a seller or trader offerer, the goods the offerer wishes to sell or trade, and a transaction price range for the goods,

(b) storing information relating to a buyer or trader acquirer, the goods the acquirer wishes to buy or trade, respectively, and a transaction price range for the goods,

(c) for a selected goods, matching one or more offerer price ranges with one or acquirer price ranges or goods, and

(d) when an overlapping price range is found in step (c), carrying out one of the following steps:

(i) alerting one or more offerers to the existence of all price-matched acquirer requests,

(ii) alerting one or more acquirers to the existence of all price-matched offerer goods,

(iii), both steps (i) and (ii), and

(iv) completed a sale or trade for a matched-price item or items between an offerer and acquirer.

Step (d) in the method may include alerting all acquirers to the existence of price-matched goods for offer, and may further include promoting bidding among said buyers for said goods.

Step (d) may include alerting one or more offerers to the existence of price-matched acquirer requests, and allowing each of the one or more offerers to select those acquirers requests for which alerts should be given in step (d).

Step (d) may include alerting one or more acquires to the existence of price-matched offerer goods, and allowing each of the one or more acquires to select those offerers to whom alerts should be given in step (d).

These and other objects and features of the invention will become more fully apparent when the following detailed description of the invention is read in conjunction with the accompanying drawings.

### BRIEF DESCRIPTION OF THE DRAWINGS

Embodiments of the invention are illustrated in the figures. However, the embodiments and figures are illustrative rather than limiting; they provide examples of the invention.

FIG. 1 depicts and example of a system for providing an electronic trading post.

FIG. 2 depicts a computer system for use in the system of FIG. 1.

FIG. 3 depicts a flowchart of an example of a method for fixed price transaction.

FIG. 4 depicts a flowchart of an example of a method for cash bid transaction.

FIG. 5 depicts a flowchart of an example of a method for limit sell order transaction.

FIG. 6 depicts a flowchart of an example of a method for exchange transaction.

FIG. 7 depicts a flowchart of an example of a method for want order transaction.

FIG. 8 depicts a flowchart of an example of a method for make me an offer transaction.

FIG. 9 depicts a flowchart of an example of a method for sell it now transaction.

FIG. 10 depicts a system that includes historical data mining on bidding data.

FIG. 11 depicts a flowchart of an example of a method for matching a buyer to a seller.

FIGS. 12A-12D depicts screenshots intended to illustrate searching as it relates to buyers, sellers, and alerts.

FIG. 13 depicts an example of a system for providing an electronic trading post.

FIGS. 14A and 14B are flow diagrams illustrating system operations for generating polytopes in the polytope market data (PMD) feature of the invention (14A), and steps for applying polytope analysis to determine is whether a new test item is valid.

FIGS. 15A-15J show polytopes for an exemplary item for sale, based on the price offered by ten different vendors.

FIGS. 16A-16C show the polytope for the average seller price among the ten vendors in FIGS. 15A-15J, (116A), and polytopes generated for two individual sellers, illustrating a fraudulent item (FIG. 16B), and a valid item (FIG. 16C).

FIGS. 17A and 17B are flow diagrams illustrating system operations for calculating cluster average prices and time-to-react values in the SIN bidding feature of the invention (17A), and steps in the presentation of bidding data offered to agents in the SIN feature (FIG. 17B).

FIGS. 18A and 18B are flow diagrams illustrating system operations for identifying Pareto trading agents and items (18A), and directed graphs illustrated a set of agents and items in the method.

FIGS. 19A and 19B are flow diagrams illustrating system operations for Buy Alerts (FIG. 19A) and Sell Alerts (FIG. 19B), in accordance with an embodiment of the invention.

FIGS. 20A and 20B are flow diagrams illustrating seller and buyer alerts, in accordance with an embodiment of the invention.

### DETAILED DESCRIPTION OF THE INVENTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

A. Basic System and Method

The techniques provided herein can be utilized and/or implemented using any known or convenient network/transmission protocol including by way of example but not limitation, Internet, enterprise distributed system, mobile, podcasting, personal satellites, broadcasting, RSS, etc. The techniques may be implemented on a variety of platforms. Examples of applicable systems are described with reference to the following figures. It should be understood that various aspects and embodiments could be implemented on other systems, as well.

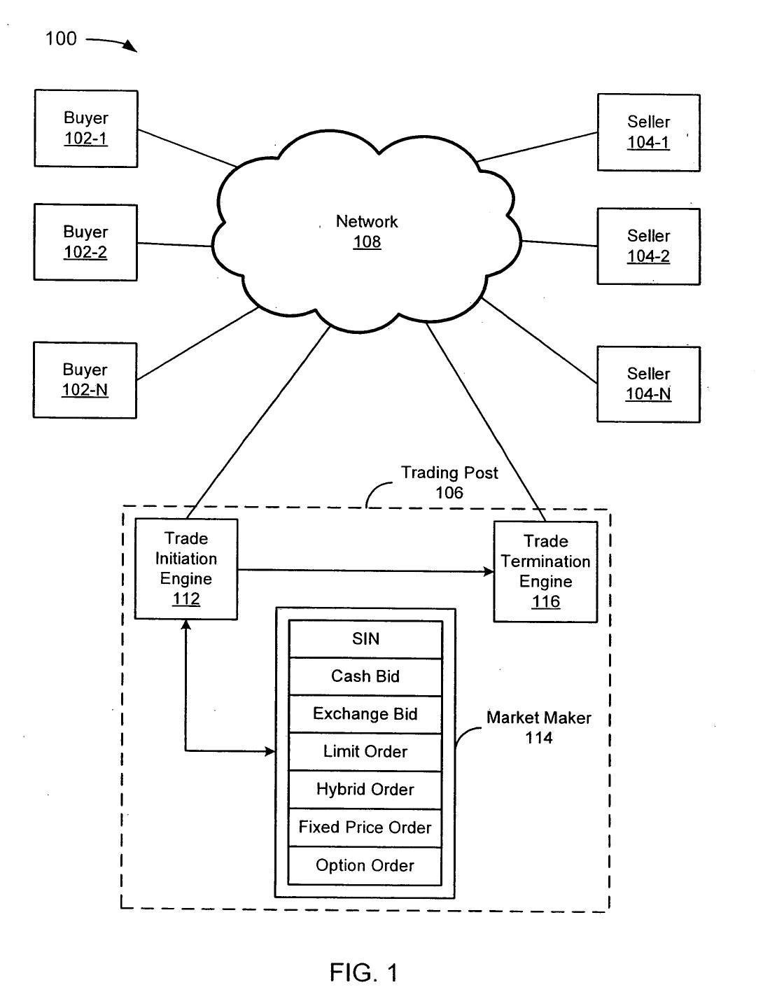

FIG. 1 depicts and example of a system 100 for providing an electronic trading post. In the example of FIG. 1, the system 100 includes a buyer 102-1 to a buyer 102-N (referred to collectively as buyers 102), a seller 104-1 to a seller 104-N (referred to collectively as sellers 104), a trading post 106, and a network 108 that couples the buyers 102, the sellers 104, and the trading post 106 together.

In the example of FIG. 1, the buyers 102, the sellers 104, and the trading post 106 may be associated with respective computer systems. One or more of the buyers 102 and the sellers 104 may be associated with a single computer system. The network may be a wide area network (WAN), such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the art.

Users on client systems, such as the buyers 102 and the sellers 104, may obtain access to the network 108 through Internet service providers (ISPs). Access to the Internet allows users of the client computer systems to exchange information, receive and send e-mails, and view documents, such as documents which have been prepared in the HTML format. These documents are often provided by web servers, which are referred to as being “on” the Internet. Often these web servers are provided by the ISPs, although a computer system can be set up and connected to the Internet without that system also being an ISP.

Client computer systems can each, with the appropriate web browsing software, view HTML pages provided by a web server. An ISP provides Internet connectivity to the client computer system through, by way of example but not limitation, a modem interface (for e.g., an analog modem, ISDN modem, or cable modem), or satellite transmission interface (.e.g., “direct PC”), Wifi, or other interface for coupling a computer system to other computer systems. The interface can be considered part of the client computer system.

Computer systems can also be coupled to a local area network (LAN), which couples the computer systems to the network 108. Client computer systems may be coupled to the LAN through network interfaces, which can be Ethernet network or other network interfaces. The LAN may also be coupled to a gateway computer system that can provide firewall and other Internet-related services for the LAN. This gateway computer system may be coupled to an ISP to provide Internet connectivity to the client computer systems. The gateway computer system can be a conventional server computer system. Alternatively, a server computer system can be directly coupled to the LAN through a network interface to provide files and other services to the buyers 102 and/or the sellers 104, without the need to connect to the Internet through the gateway system.

It should be noted that the buyers 102 and the sellers 104 need not have significant or noticeable differences. A transaction may define a buyer and a seller depending upon implementation and the definition need not be logical or even consistent so long as the transactions proceed according to the expectations of the parties. For example, a buyer may offer to buy an item and a seller may accept the offer and sell the item. However, a “buyer” could also request a “seller” trade one item for another. The buyer is difficult to identify, since both parties are providing goods for exchange with the other. The system 100 may or may not distinguish buyer and seller in every transaction, or may arbitrarily determine who is buyer and who is seller.

The trading post 106 may include at least one computer system which operates as a server computer system and is configured to operate with the protocols of the World Wide Web and is coupled to the Internet. The trading post 106 can be a conventional server computer system. Optionally, the trading post 106 can be part of an ISP which provides access to the Internet for client systems. The trading post 106 may be coupled to a server computer system (not shown) which itself is coupled to the network 108. While the buyers 102 and the sellers 104 are depicted in the example of FIG. 1 as remote with respect to one another, in an alternative embodiment the trading post 106 can include a computer system having different software components that allow a buyer or seller to be coupled to the network 108 through the trading post 106.

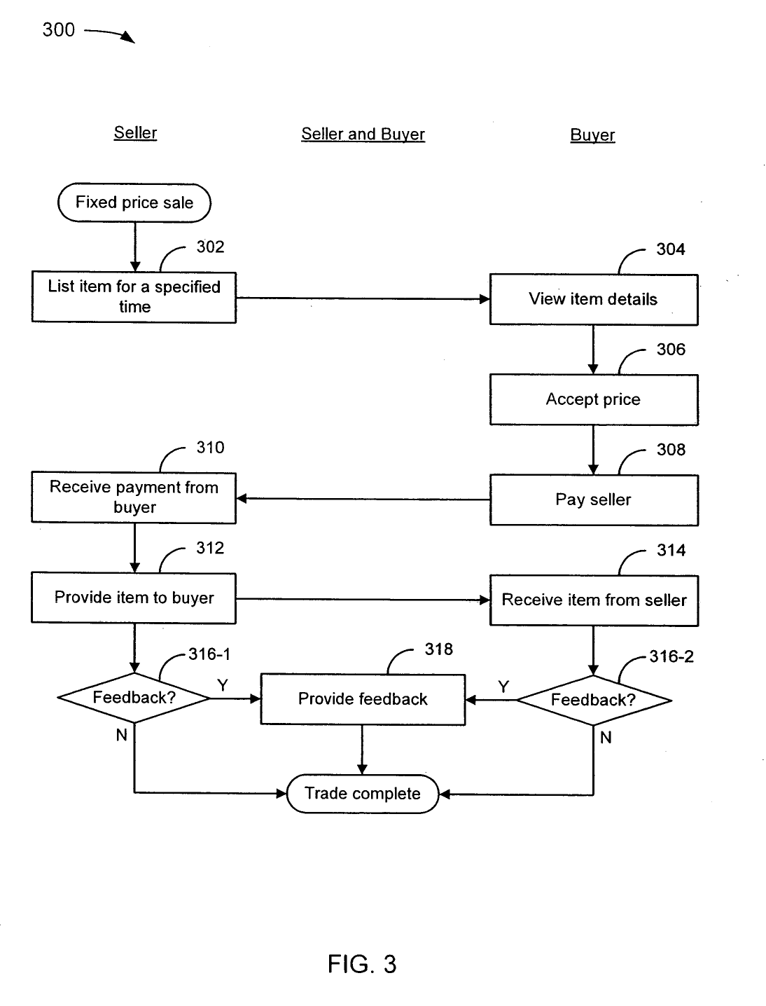

In the example of FIG. 1, the trading post 106 includes a trade initiation engine 112, a market maker 114, and a trade termination engine 116. The trade initiation engine 112 includes triggers that indicate a transaction is being initiated. For example, if a seller puts an item up for sale, that may cause the trade initiation engine 112 to trigger transaction procedures. The market maker 114 may include mechanisms to monitor and regulate transactions. For example, the market maker 114 can suggest trading tools to the trade initiation engine 112 that are appropriate for the type of transaction initiated (e.g., sell it now (SIN), cash bid, exchange bid, limit order, hybrid order, fixed price order, option order, last resort sale, reverse bidding, group trading, other tools, or a combination of tools). Some of the types of transactions are described later for the purpose of example with reference to FIGS. 3-9. The trade termination engine 116 includes triggers that indicate a transaction has been terminated. For example, after seller and buyer have provided feedback trade settlement terms, the trade termination engine 116 may close the transaction.

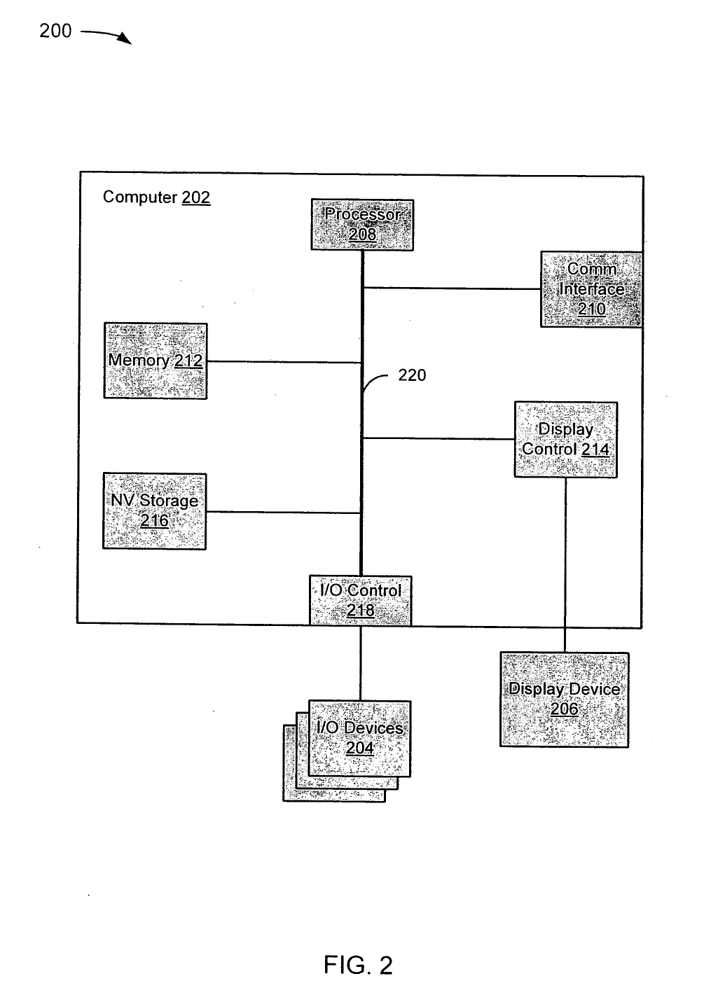

FIG. 2 depicts a computer system 200 for use in the system 100 (FIG. 1). The computer system 200 may be a conventional computer system that can be used as a client computer system, such as a wireless client or a wired client, or a server computer system. The computer system 200 includes a computer 202, I/O devices 204, and a display device 206. The computer 202 includes a processor 208, a communications interface 210, memory 212, display controller 214, non-volatile storage 216, and I/O controller 218. The computer 202 may be coupled to or include the I/O devices 204 and display device 206.

The computer 202 interfaces to external systems through the communications interface 210, which may include a modem or network interface. It will be appreciated that the communications interface 210 can be considered to be part of the computer system 200 or a part of the computer 202. The communications interface 210 can be an analog modem, ISDN modem, cable modem, token ring interface, satellite transmission interface (e.g. “direct PC”), or other interfaces for coupling a computer system to other computer systems.

The processor 208 may be, for example, a conventional microprocessor such as an Intel Pentium microprocessor or Motorola power PC microprocessor. The memory 212 is coupled to the processor 208 by a bus 220. The memory 212 can be Dynamic Random Access Memory (DRAM) and can also include Static RAM (SRAM). The bus 220 couples the processor 208 to the memory 212, also to the non-volatile storage 216, to the display controller 214, and to the I/O controller 218.

The I/O devices 204 can include a keyboard, disk drives, printers, a scanner, and other input and output devices, including a mouse or other pointing device. The display controller 214 may control in the conventional manner a display on the display device 206, which can be, for example, a cathode ray tube (CRT) or liquid crystal display (LCD). The display controller 214 and the I/O controller 218 can be implemented with conventional well known technology.

The non-volatile storage 216 is often a magnetic hard disk, an optical disk, or another form of storage for large amounts of data. Some of this data is often written, by a direct memory access process, into memory 212 during execution of software in the computer 202. One of skill in the art will immediately recognize that the terms “machine-readable medium” or “computer-readable medium” includes any type of storage device that is accessible by the processor 208 and also encompasses a carrier wave that encodes a data signal.

The computer system 200 is one example of many possible computer systems which have different architectures. For example, personal computers based on an Intel microprocessor often have multiple buses, one of which can be an I/O bus for the peripherals and one that directly connects the processor 208 and the memory 212 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 212 for execution by the processor 208. A Web TV system, which is known in the art, is also considered to be a computer system, but it may lack some of the features shown in FIG. 2, such as certain input or output devices. A typical computer system will usually include at least a processor, memory, and a bus coupling the memory to the processor.

In addition, the computer system 200 is controlled by operating system software which may include a file management system, such as a disk operating system, that is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 216 and causes the processor 208 to execute the various acts required by the operating system to input and output data and to store data in memory, including storing files on the non-volatile storage 216.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Apparatus used to perform operations described herein may be specially constructed for the desired purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

FIG. 3 depicts a flowchart 300 of an example of a method for fixed price transaction. This method and other methods are depicted as serially arranged modules. However, modules of the methods may be reordered, or arranged for parallel execution as appropriate. FIGS. 3-9 are intended to illustrate other potential transactions that may be facilitated by a transaction engine, such as the market maker engine 114 (FIG. 1). FIGS. 3-9 are for illustrative purposes only and may include only a subset of potential transactions, and some implementations may not include all of the illustrated transactions.

In the example of FIG. 3, the flowchart 300 starts at module 302 where an item is listed for a specific time by a seller. A specified time may include an arbitrary time, a pre-determined time, a scheduled time, a dynamically determined time, or some other period of time during which the item is listed. For example, the system could, at a dynamically determined time, sell for a seller when demand is high, but supply is low. The item may be listed at a listing agent. Alternatively, the item may be listed for sale at the seller's location, rather than listing the item at a listing agent, and the system could capture the data using active or passive data acquisition techniques. The item listing may include data from the seller that is free-form (i.e., sellers can enter whatever data they like). Instead or in addition, a system could provide static information, such as a format for entering data, and limitations on data fields, and dynamic automatic information, such as a price of a specific item when the item is new, or a blue book value of a car.

In the example of FIG. 3, the flowchart 300 continues to module 304 where a buyer views item details. Typically, the buyer can view item details through a browser, but any known or convenient technique could be used to view the item details. It may be noted that the buyer could select a transaction “view item details” that, from the perspective of the buyer, is a start of the transaction.

In the example of FIG. 3, the flowchart 300 continues to module 306 where the buyer accepts the price. Since this is a fixed price sale example, the transaction is relatively simple, involving a posting of an item with price, and acceptance thereof.

In the example of FIG. 3, the flowchart 300 continues to module 308 where the buyer pays the seller (e.g., by sending payment to the seller), to module 310 where the seller receives payment from the buyer, to module 312 where the seller provides the item to the buyer (e.g., by shipping the item or allowing download), and to module 314 where the buyer receives the item from the seller.

In the example of FIG. 3, the flowchart 300 continues to decision point 316-1 and 316-2 where it is determined whether the seller and/or buyer, respectively, are interested in providing feedback. If so, the flowchart 300 continues to module 318 where the feedback is provided by one or both of the seller and buyer. If not, or in any case after feedback has been received, the flowchart 300 ends and the trade is complete. It may be noted that feedback could be, for example, a seller indicating that payment has not been received. This feedback would result in the trade being incomplete, or in a verification stage. However, for illustrative simplicity, it is assumed that the feedback is of the type that allows the trade to be identified as complete.

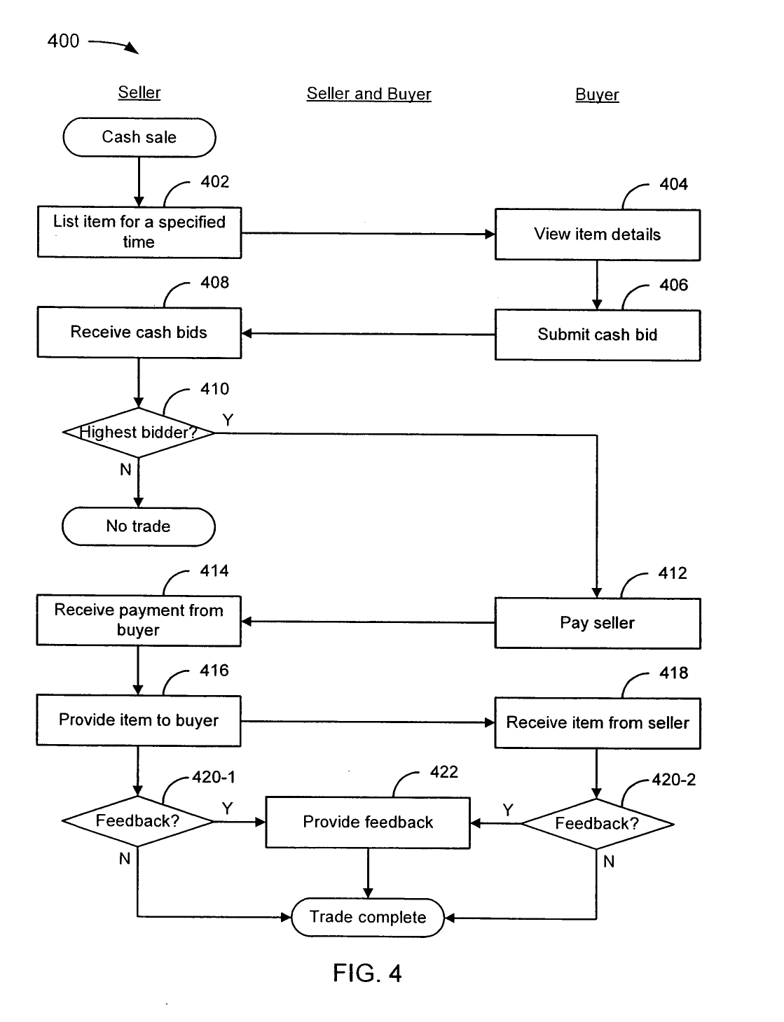

FIG. 4 depicts a flowchart 400 of an example of a method for cash bid transaction. In the example of FIG. 4, the modules 402, 404, and 412-422 are similar to the modules 302, 304, and 308-318 so descriptions are shortened or omitted.

In the example of FIG. 4, the flowchart 400 starts at module 302 where an item is listed for a specific time by a seller. In the example of FIG. 4, the flowchart 400 continues to module 404 where a buyer views item details.

In the example of FIG. 4, the flowchart 400 continues to module 406 where the buyer submits a cash bid. Presumably, other potential buyers will also submit bids if the potential buyers are interested in the item. In an embodiment, bids can be submitted by potential buyers for the entire duration of the time specified at module 402. In an embodiment, the end time may be extended by the system if a bid is placed in the last minutes that the item is offered to avoid shill bidding.

In the example of FIG. 4, the flowchart 400 continues to module 408 where the seller receives the cash bids, and to decision point 410 where the highest bidder is determined. If a bidder is not the highest bidder (410-N), then there is no transaction with respect to that bidder. However, if a bidder is the highest bidder (410-Y), then the flowchart 400 continues to module 412, and eventually to module 422.

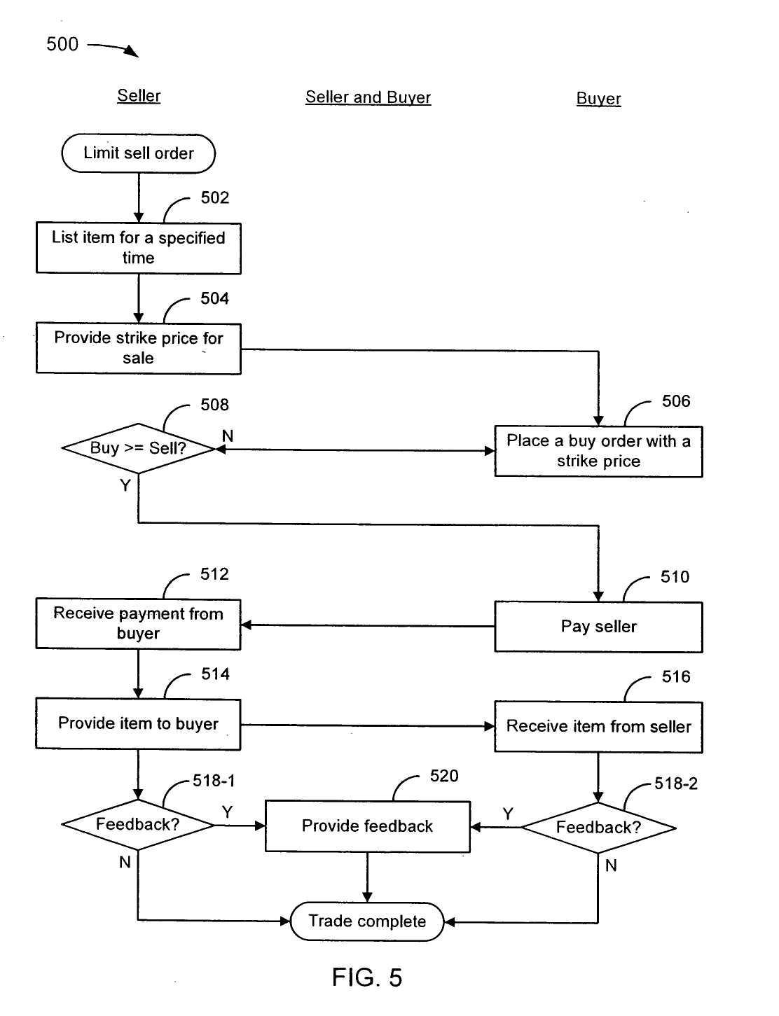

FIG. 5 depicts a flowchart 500 of an example of a method for limit sell order transaction. Limit buy order transactions may be accomplished in a manner that is sufficiently similar to limit sell orders that those of skill in the relevant art with FIG. 5 and the associated text before them would understand how to accomplish limit buy order transactions. In the example of FIG. 5, the modules 502 and 510-520 are similar to the modules 302 and 308-318 so descriptions are shortened or omitted.

In the example of FIG. 5, the flowchart 500 starts at module 502 where an item is listed for a specific time by a seller. In the example of FIG. 5, the flowchart 500 continues to module 504 where the seller provides a strike price for sale. A strike price is the price at which a seller is willing to sell. In the example of FIG. 5, the flowchart 500 continues to module 506 where a buy order with a strike price is placed by a buyer. In the example of FIG. 5, the flowchart 500 continues to decision point 508 where it is determined whether the buy strike price is equal to or greater than the sell strike price. If not (506-N), then the flowchart 500 waits for a buy order with a strike price that meets this requirement. If so (506-Y), then the flowchart 500 continues to module 510, and eventually to module 520.

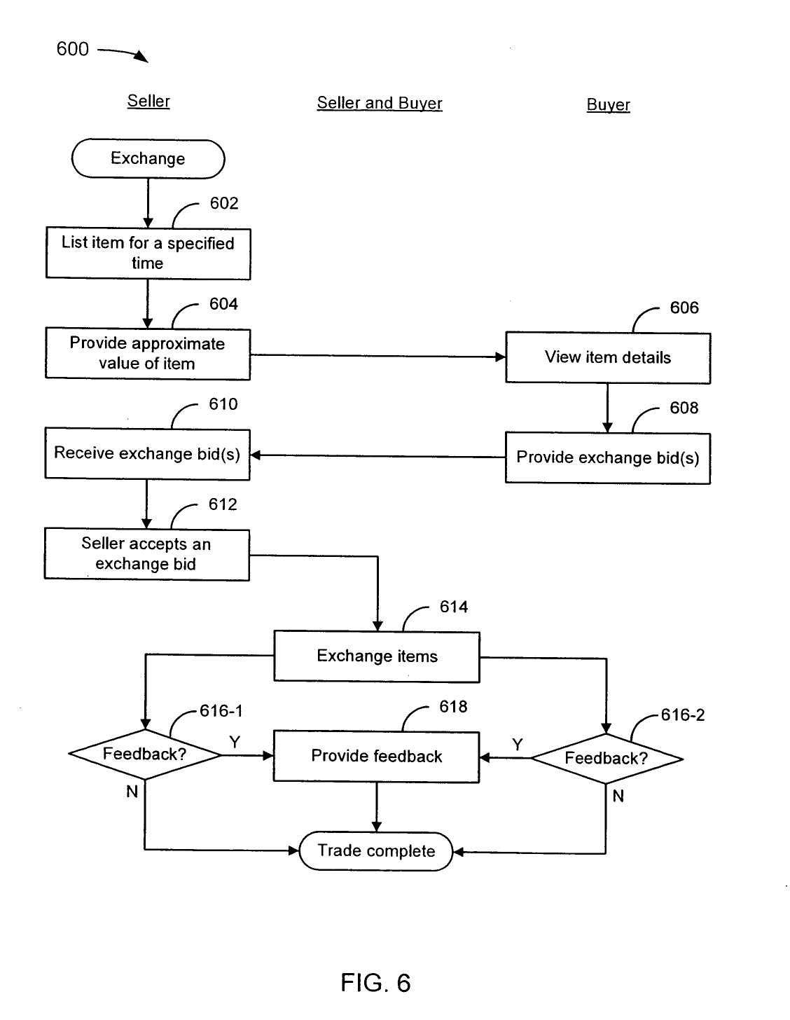

FIG. 6 depicts a flowchart 600 of an example of a method for exchange transaction. In the example of FIG. 6, the modules 602, 616, and 618 are similar to the modules 302, 316, and 318 so descriptions are shortened or omitted.

In the example of FIG. 6, the flowchart 600 starts at module 602 where an item is listed for a specific time by a seller. In the example of FIG. 6, the flowchart 600 continues to module 604 where the seller provides an approximate value of the item. In a non-limiting embodiment, the seller may limit the exchange type to a like type (e.g., if a baseball card is offered for exchange, the seller may require one or more baseball cards in exchange) or some other specified type of item.

In the example of FIG. 6, the flowchart 600 continues to module 606 where a buyer views item details, and to module 608 where the buyer provides one or more exchange bids. For example, the buyer may offer multiple items that the seller may pick and choose between.

In the example of FIG. 6, the flowchart 600 continues to module 610 where the seller receives the exchange bids, and to module 612 where the seller accepts on of the exchange bids. The exchange bids may come from multiple potential buyers.

In the example of FIG. 6, the flowchart 600 continues to module 614 where the buyer and seller exchange items, to decision point 616, and to module 618, if applicable.

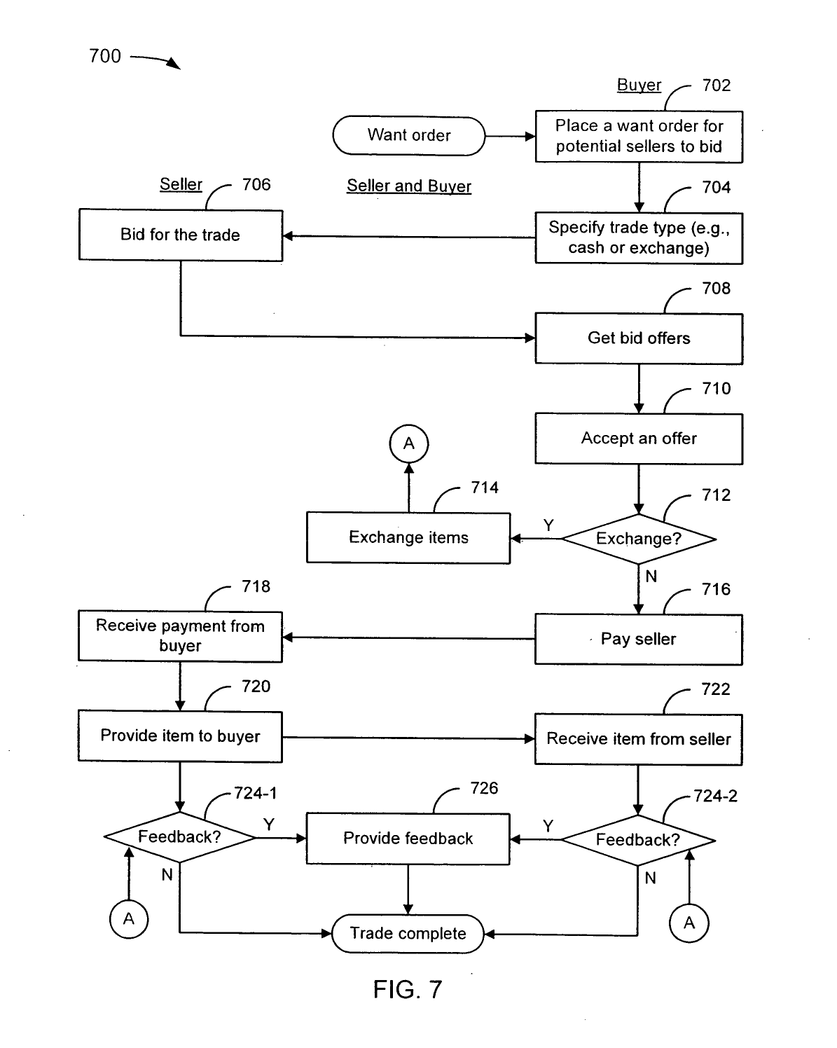

FIG. 7 depicts a flowchart 700 of an example of a method for want order transaction. In the example of FIG. 7, the modules 716-726 are similar to the modules 308-318 so descriptions are shortened or omitted.

In the example of FIG. 7, the flowchart 700 starts at module 702 where a buyer places a want order for potential sellers to bid on. In the example of FIG. 7, the flowchart 700 continues to module 704 where the buyer specifies the trade type (e.g., cash or exchange). In the example of FIG. 7, the flowchart 700 continues to module 706 where the seller bids for the trade. In the example of FIG. 7, the flowchart 700 continues to module 708 where the buyer gets bid offers from the seller, and from other sellers if available. In the example of FIG. 7, the flowchart 700 continues to module 710 where the buyer accepts an offer. In the example of FIG. 7, the flowchart 700 continues to decision point 712 where it is determined whether an exchange is desired. This may be determinable from the specification at module 704. If it is determine that an exchange is desired (712-Y), then the flowchart 700 continues to module 714, where the buyer and the seller exchange items, to decision points 724-1 and 724-2, and to module 726. If it is determined that an exchange is not desired (712-N), then the flowchart 700 continues to module 716, and eventually to module 726.

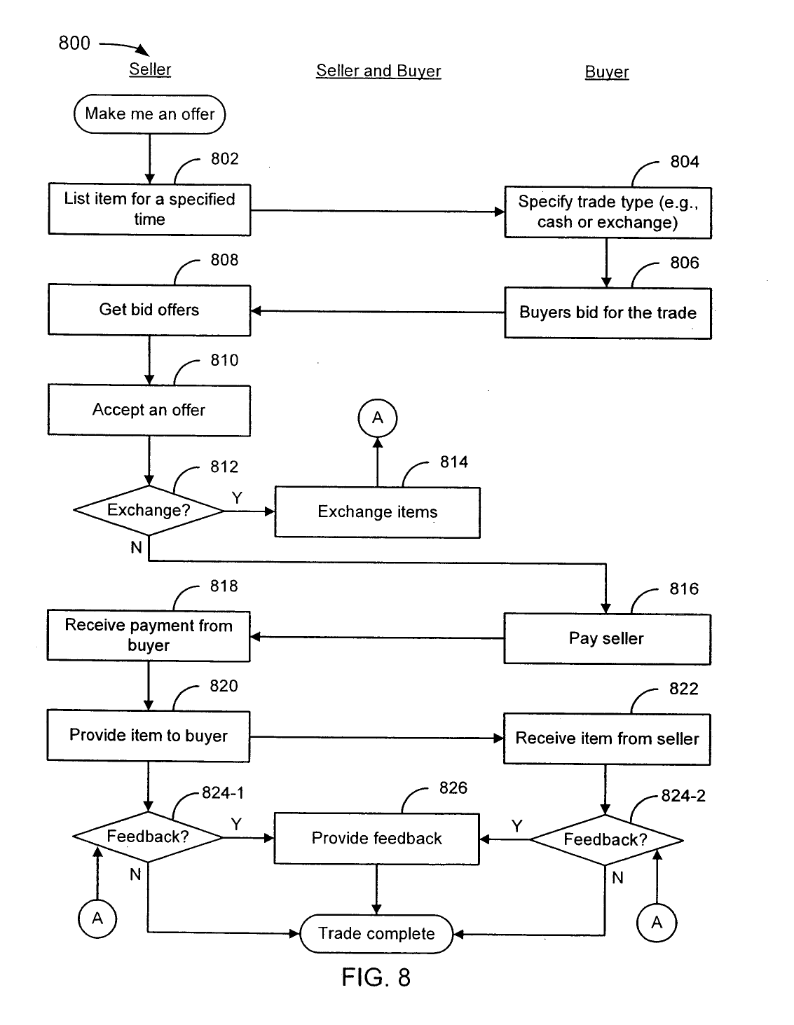

FIG. 8 depicts a flowchart 800 of an example of a method for make me an offer transaction. In the example of FIG. 8, the modules 812-826 are similar to the modules 712-726 so descriptions are shortened or omitted.

In the example of FIG. 8, the flowchart 800 begins at module 802 with listing an item for a specified time by a seller. The flowchart 800 continues at module 804 where a buyer specifies a trade type, to module 806 where the buyer bids for the trade, to module 808 where the seller gets the bid offer (including other potential seller bid offers, if any), to module 810 where the seller accepts an offer, to module 812, and eventually to module 826.

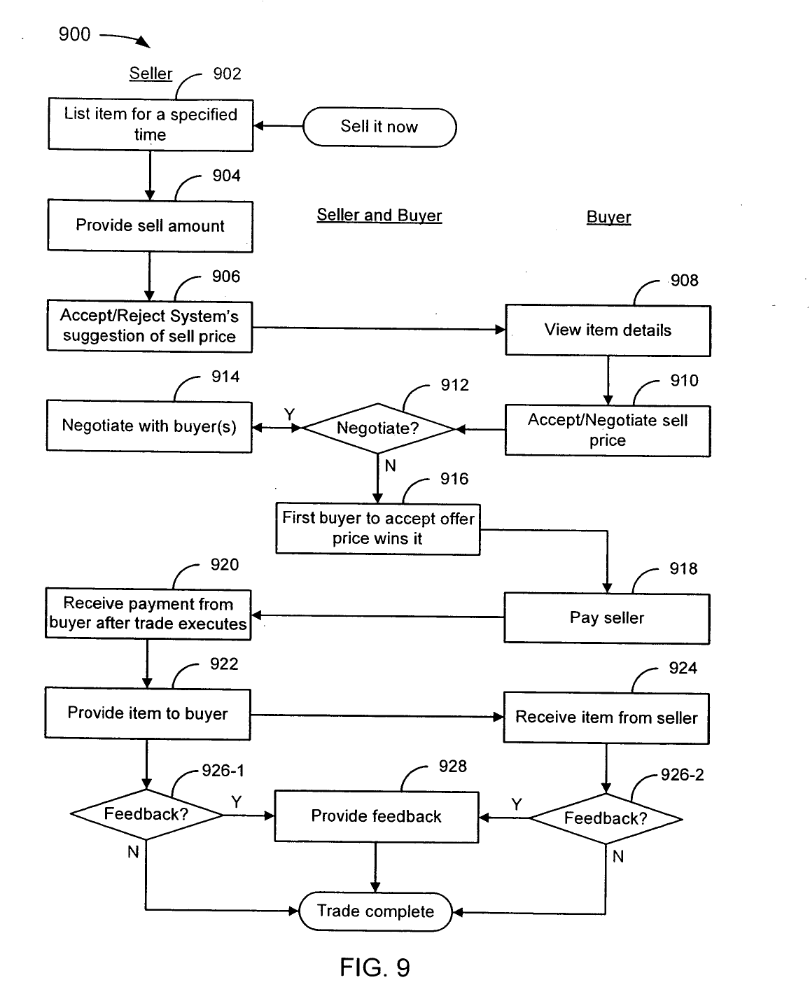

FIG. 9 depicts a flowchart 900 of an example of a method for sell it now transaction. In the example of FIG. 9, the modules 902 and 918-928 are similar to the modules 302 and 308-318 so descriptions are shortened or omitted.

In the example of FIG. 9, the flowchart 900 starts at module 902 where a seller lists an item for a specified time. In the example of FIG. 9, the flowchart 900 continues to module 904 where the seller provides a sell amount and to module 906 where the seller accepts or rejects the system's suggestion of a sell price. As is discussed later, since the system maintains historical data for potential buyers and sellers, the system can come up with a pretty good value range at which goods can be offered. A seller (or buyer) can then conduct trades more effectively.

In the example of FIG. 9, the flowchart 900 continues at module 908 where the buyer views item details, to module 910 where the buyer accepts or negotiates sell price, and to decision point 912 where it is determined whether the buyer wishes to negotiate. If it is determined that the buyer wishes to negotiate (912-Y), then the flowchart 900 continues to module 914 where the seller negotiates with the buyer. If it is determined that the buyer does not wish to negotiate (912-N), either from the outset or after negotiations are concluded, then the flowchart 900 continues to module 916 where the first buyer to accept the seller's offer wins the transaction, to module 918, and eventually to module 928.

It may be noted that some of the transactions described for the purposes of example, such as those of FIG. 3 and 4, do not have significant requirements to implement effectively. Fixed price sales are relatively straight-forward, allowing a seller to list an item and a buyer to pick the item from the list for purchase, and bidding is only moderately complex and, in any event, well-known in e-commerce. Other transactions, such as those of FIGS. 5-9, begin to introduce new complexities. For example, FIG. 9 requires some type of systemic knowledge regarding buyer patterns to enable the system to suggest a price. It also would function more smoothly if the buyer information is such that negotiations are possible with relative efficiency. Still other transactions, such as reserve price auctions, should be understandable to those of skill in the relevant art with these teachings before them.

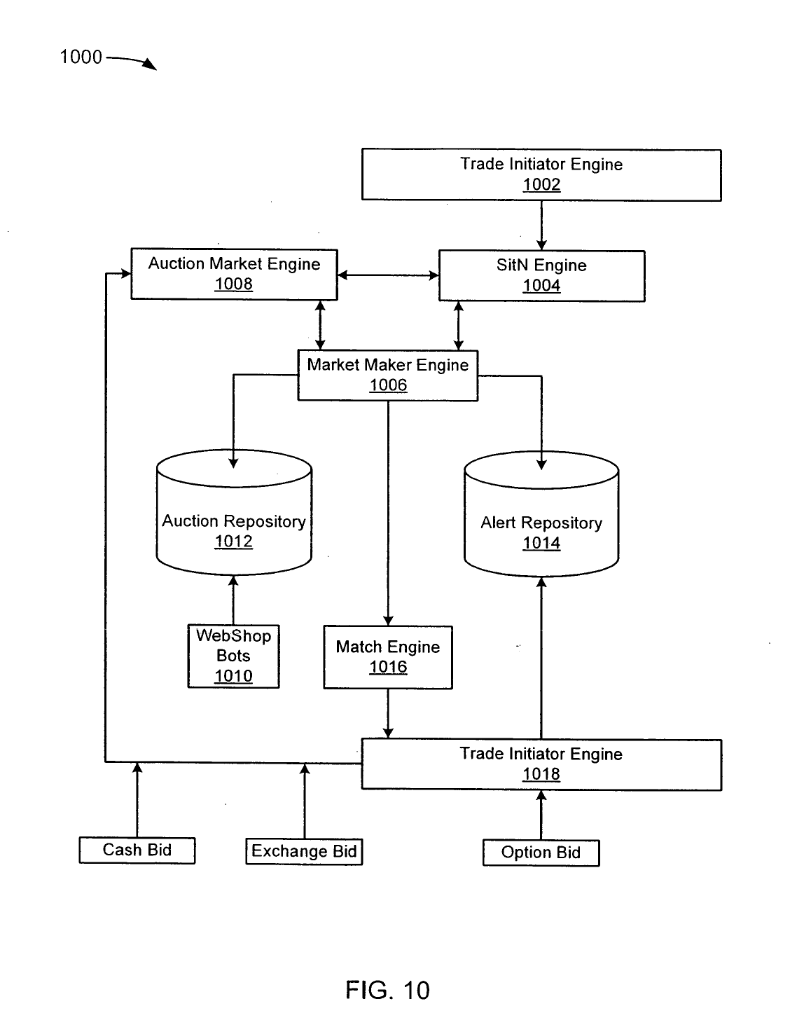

FIG. 10 depicts a system 1000 that includes historical data mining on bidding data. By maintaining the historical bidding data, the system 1000 can give a “second chance” to potential buyers who can be engaged by sellers of the same or similar items that the buyers were interested in. In addition, standing offers can be made to purchase an item at a particular price. The system can use the historical data to create a range of prices at which buyers are willing to purchase a particular item. Using the historical data, the seller can increase the odds of a quick sale to specifically targeted potential buyers.

Buyers and sellers can also create sales alerts (with or without commitment) indicating an interest in a particular item. Alerts increase the amount of historical data available to the system by adding what amounts to “standing offers” to the historical data. Alerts without commitment can be valuable, even thought they are not really offers, to gauge interest for a particular item. Using the tools available, a trader can buy an item low and sell high roughly concurrently, or sell-before-you-buy (also known as “shorting”). This is possible even with hard assets.

In the example of FIG. 10, the system includes a trade initiator engine 1002, a sell it now (SIN) engine 1004, a market maker engine 1006, an auction market engine 1008, web shop bots 1010, an auction repository 1012, an alert repository 1014, an match engine 1016, and a trade terminator 1018. The trade initiator engine 1002 is triggered to initiate a new transaction. For illustrative purposes, it is assumed that previous transactions have already occurred so as to build up historical data in the auction repository 1012, and the alert repository 1014.

The trade initiator engine 1002 triggers the SIN engine 1004 to attempt to match the party associated with the new transaction (for illustrative purposes, it is assumed that this party is the seller) with another party (the buyer). The SIN engine 1004 works with the market maker engine 1006 to match the seller with a buyer according to the requirements of the type of trade or requirements of the buyer or seller.

The market maker engine 1006 may or may not use the auction market engine 1008 to solicit bids for the new transaction or for previous transactions. In either case, the auction market engine 1008 can generate historical data that is stored in the auction repository 1012. The web shop bots 1010 can also scour the web to find other information regarding buyers or sellers that can be stored in the auction repository 1012. In another embodiment, other data mining tools may be used to find data on other networks. For example, the system 1000 may tap into a commercial site to find current prices, and facilitate matching buyers to sellers using this third party data.

Advantageously, the market maker engine 1006 can negotiate with a seller or buyer, apart from negotiations between the parties, to attempt to bring the buying or selling price as close to the going rate as possible. For example, if a seller makes an offer to sell an item for $1,000.00, but the item normally goes for around $50.00, the system can let the seller know that the price is way out of the usual range. The seller can act on this information or not, as desired. Similarly, a buyer can be informed when an offer to buy is lower than the going amount.

As the market maker engine 1006 attempts to match the seller with a buyer, the market maker engine 1006 may also generate historical data for storage in the auction repository 1012 (e.g., by learning what offers were acceptable during negotiations) or alerts for storage in the alert repository 1014. When the transaction is accomplished, the market maker 1006 may pass control to the match engine 1016, though the market maker 1006 may concurrently continue to operate on this and/or other transactions.

The match engine 1016 eventually puts a buyer and seller together. The match engine 1016 may put a buyer with a seller using historical data from the auction repository 1012 or alerts from the alert repository 1014. In a non-limiting embodiment, alerts could be generated from historical data so that all matches are from matching alerts from the alert repository 1014. In such an embodiment, the match engine 1016 could be referred to as an “alert match engine.”

The trade terminator engine 1018 is triggered when the transaction is completed. In a non-limiting embodiment, the trade terminator engine 1018 may query buyer and seller for feedback regarding the system 1000, one another, or some other subject. The trade terminator engine 1018 can update the alert repository (e.g., if an alert is satisfied, it can be disabled or deleted, depending upon the implementation). Data related to the transaction can also be sent to the auction market engine 1008, which can in turn update the auction repository 1012. For example, if a party just lost a bid, the party can be identified in the auction repository 1012, or an alert can be generated on behalf of the party and stored in the alert repository 1014.

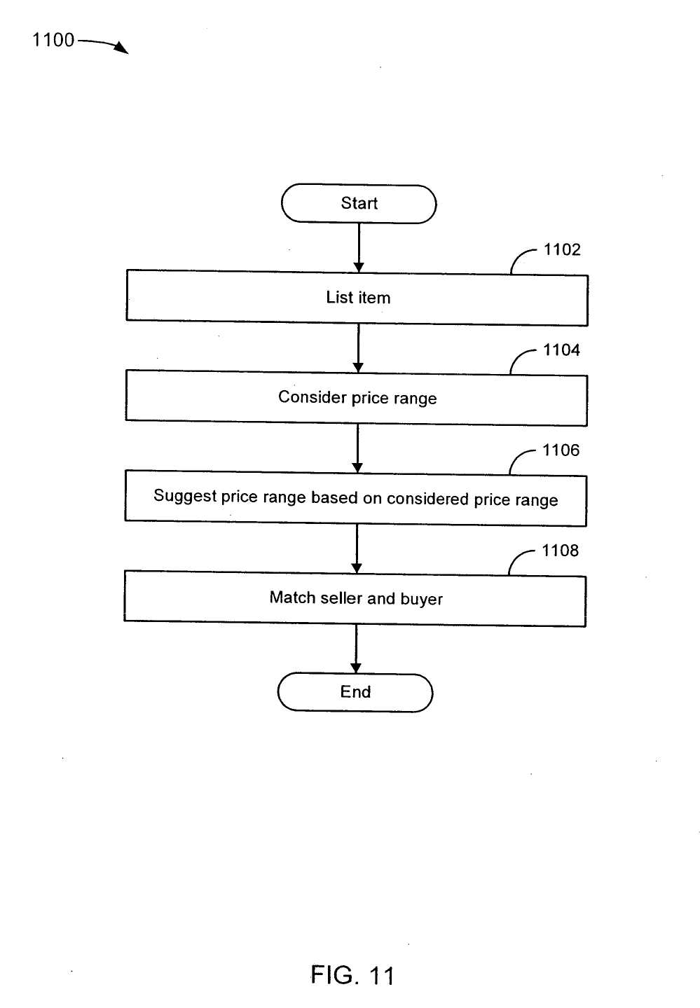

FIG. 11 depicts a flowchart 1100 of an example of a method for matching a buyer to a seller. In the example of FIG. 11, the flowchart 1100 starts at module 1102 where a first party lists an item. For illustrative purposes, the first party is assumed to be a seller (the first party could also be a buyer). It may be noted that the listing of the item need not be according to the rules of a typical listing agent. For example, the seller could “list” an item by creating an alert that the seller is interested in selling an item. Both buyers and sellers are able to generate alerts, and the alerts can be used to match buyer and seller together.

In the example of FIG. 11, the flowchart 1100 continues to module 1104 where an expert system generates a price range that is consistent with historical and alert data. The price range can be generated using data such as that regarding potential buyers who lost bids in an auction, potential buyers associated with alerts, or other data that is deemed useful in calculating a range.

In the example of FIG. 11, the flowchart 1100 continues at module 1106 where a price is suggested based on the buyer price range. To sell at maximum profit per unit, a seller may choose the highest price in the price range. Or the seller may wish to pick a number roughly in the middle of the pack, and then negotiate with the buyers or ask them to bid for the item. To include the maximum number of potential buyers in the negotiations or auction, the seller might offer to sell at the lowest price in the price range.

In the example of FIG. 11, the flowchart 1100 continues at module 1108 where the seller is matched to a buyer. Advantageously, it is possible to sell an item as soon as the item is “listed.” For example, the seller could simply work with the system at module 1106 to match the item to the highest price in the price range, and sell to that buyer. If the seller has multiple identical items, the seller could sell to the highest, next highest, on down the line until the seller runs out of items or is not interested in selling at a lower price.

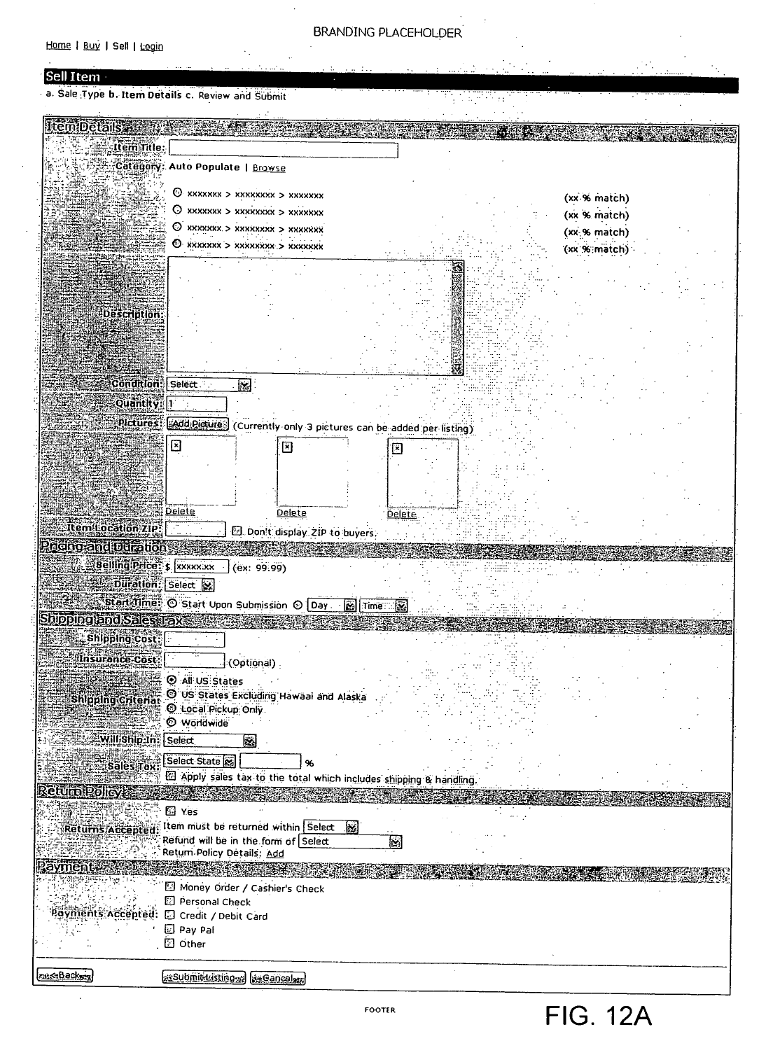

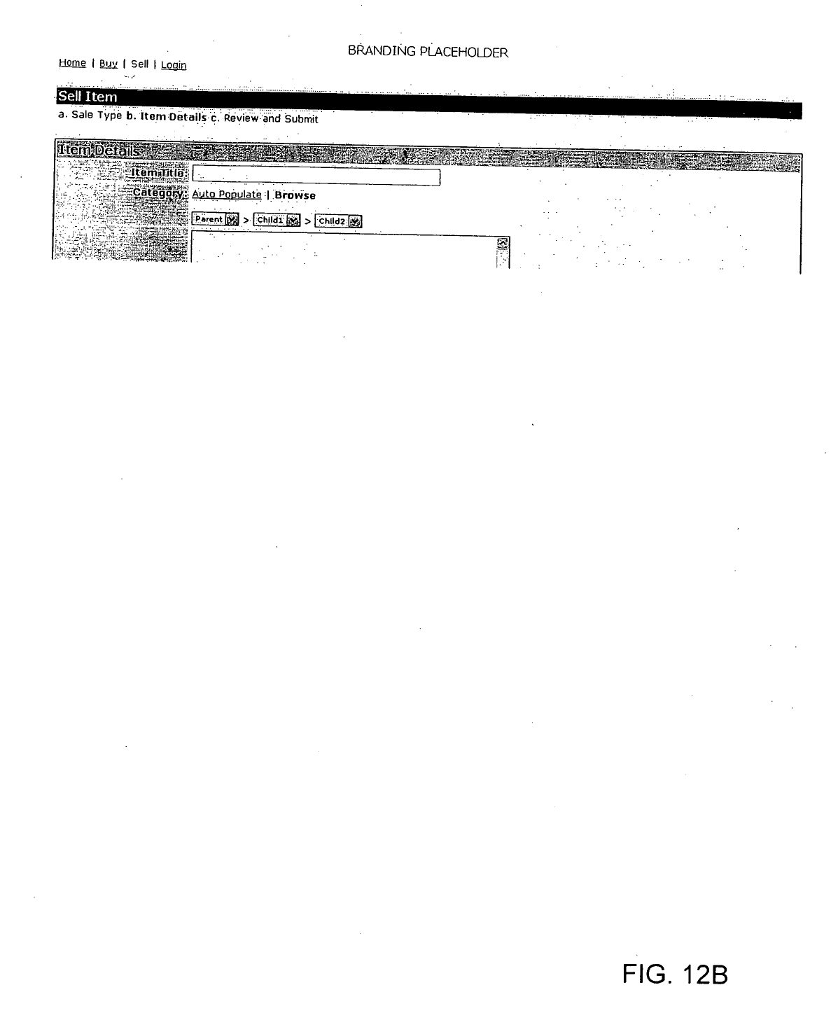

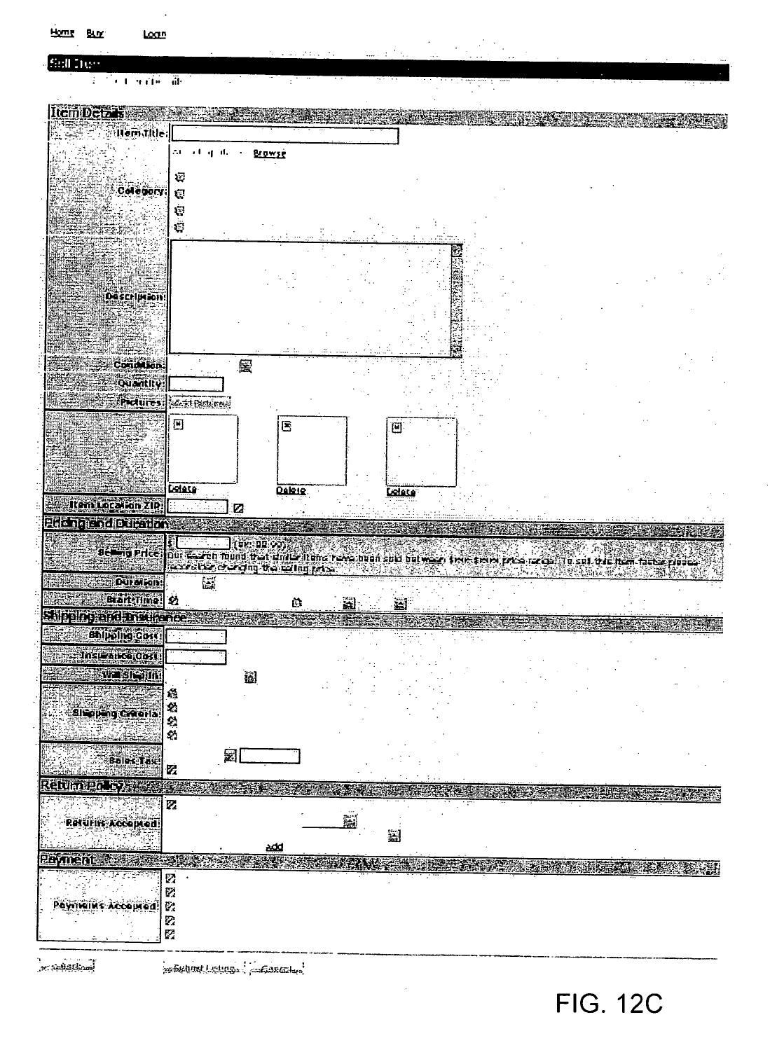

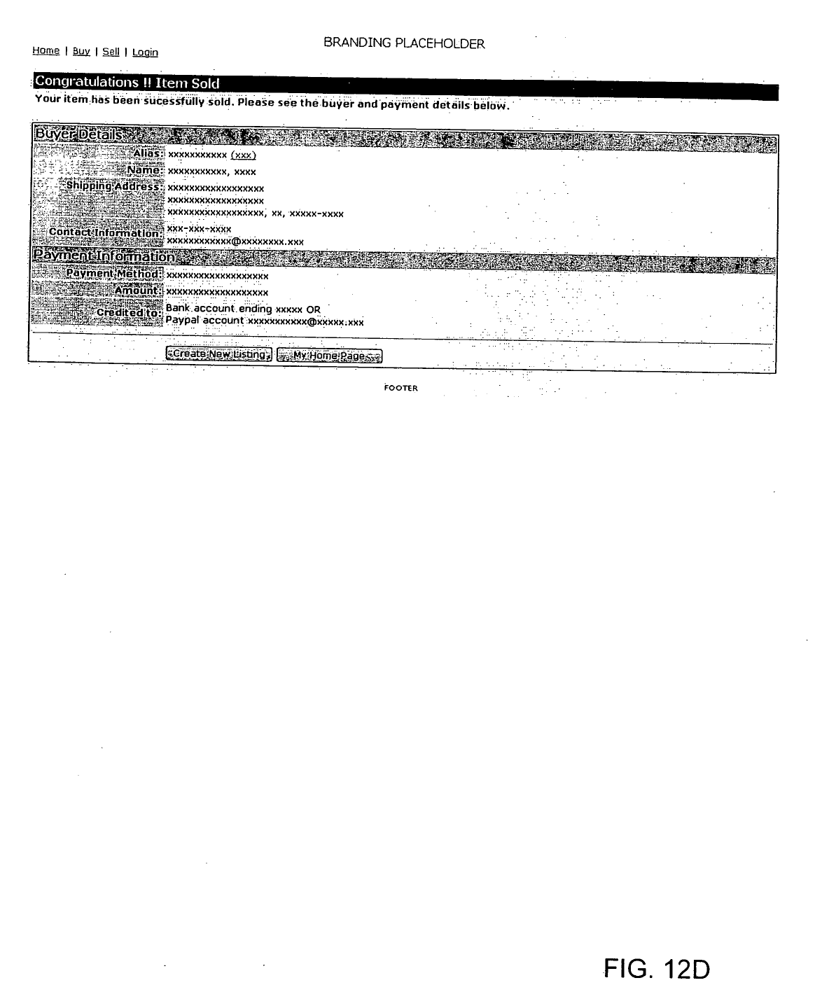

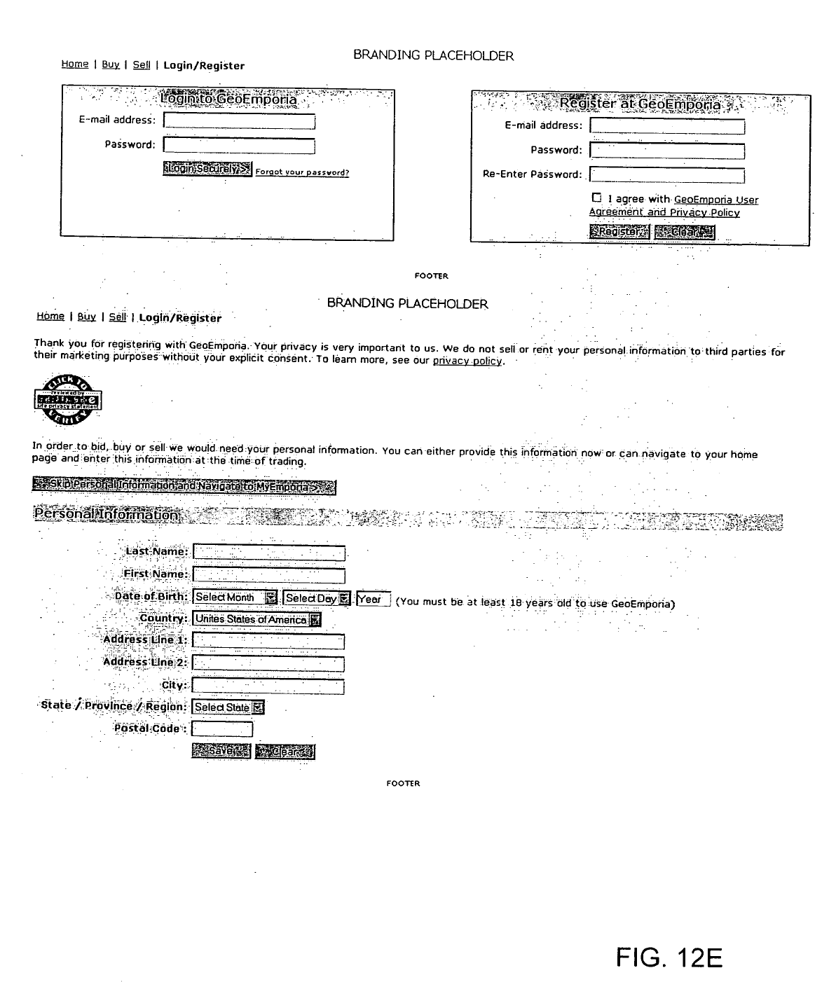

FIGS. 12A-12D depict screenshots intended to illustrate searching as it relates to buyers, sellers, and alerts. Advantageously, the buyer and seller can use what appears to be the same technique to find an item for sale or purchase, or to submit an alert to the system.

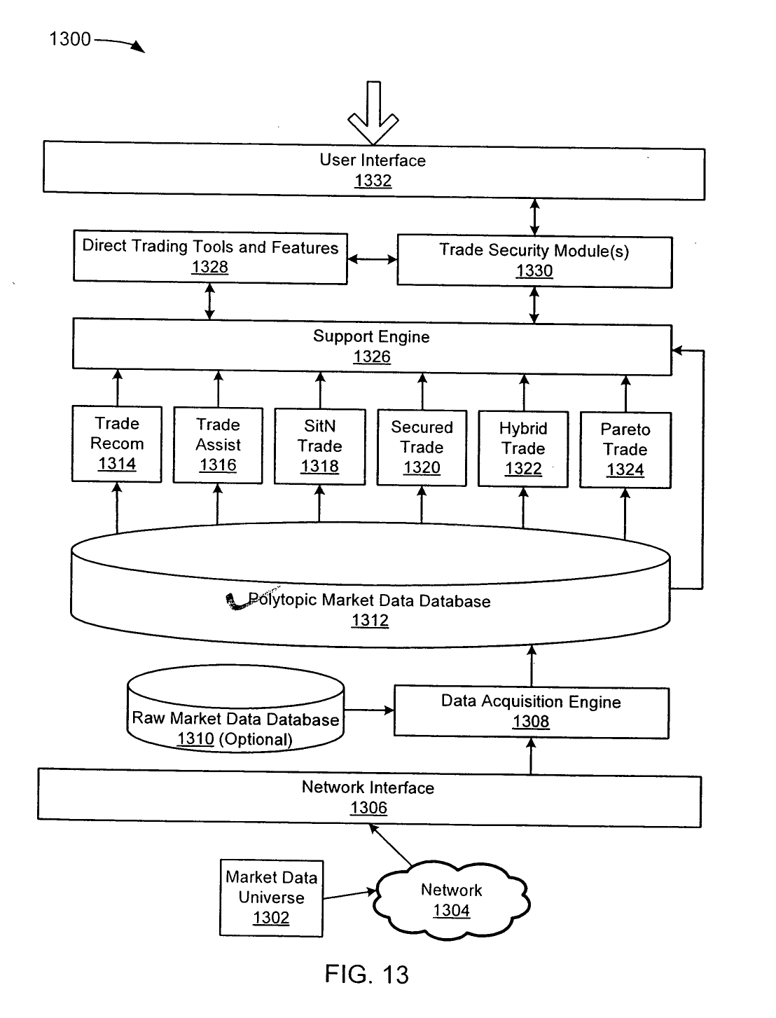

FIG. 13 depicts an example of a system 1300 for providing an electronic trading post. In the example of FIG. 13, the system 1300 includes a market universe 1302, a network 1304, a network interface 1306, a data acquisition engine 1308, a raw market data database 1310 (optional), a polytopic market (PMD) database 1312, a trade recommendation module 1314, a trade assistance module 1316, a sell-it-now (SitN) trade module 1318, a secured trade module 1320, a hybrid trade module 1322, a Pareto trade module 1324, a support module(s) engine 1326, a direct trading tools and features engine 1328, a trade security module(s) engine 1330, and a user interface 1332.

In the example of FIG. 13, the market data universe 1302 is coupled to the network 1304. In an embodiment, the network 1304 could be, for example, the Internet or some other WAN or LAN. Thus, the market data universe 1302 could theoretically include just about any market data that could be obtained over the Internet. Although, naturally, data will be passing from the network 1304 to the market data universe 1302, in the example of FIG. 13, an arrow is directed from the market data universe 1302 to the network 1304 to show that market data is flowing from the market data universe 1302.

In the example of FIG. 13, the network 1304 is coupled to the network interface 1306. In an embodiment, the network interface 1306 could be a network interface to a single server computer that acts as a trading post. Alternatively, the network interface could be a network interface to a LAN on which multiple devices may act together to serve as a trading post. Alternatively, the various components of the system 1300 could be distributed across a WAN, but function together to act as a trading post. Thus, the network interface could be for a computer, a gateway for a LAN, or a collection of network interfaces that connect the various components of the trading post to the network 1304 and/or to one another. In the example of FIG. 13, an arrow is directed from the network 1304 to the network interface 1306 to represent that market data is flowing from the market data universe 1302 through the network 1304 to the network interface 1306.

In the example of FIG. 13, the network interface 1306 is coupled to the data acquisition engine 1308. In an embodiment, the data acquisition engine 1308 may include data acquisition modules, such as crawlers and other data acquisition tools, that are actively sent out to the market data universe 1302 to harvest data. The data acquisition modules may also include passive data acquisition tools that simply receive data from the market data universe 1302 without proactive probing or other activity. The data acquisition engine 1308 may also include data acquisition filters to sort, restrict, and/or modify data in such a way that the data is more useful to the trading post. The data acquisition engine 1308 may receive data from the network interface 1308 or from the raw market data database 1310. It may be noted that the raw market data database 1310 is optional because the system 1300 may function without any local data or data generated internally by the trading post, which is what the raw market data database 1310 is intended to represent. To represent the market data that is input to the data acquisition engine 1308 (through active or passive means), arrows are directed from the market data universe 1302 to the data acquisition engine 1308 and from the raw market data database 1310 to the data acquisition engine 1308.

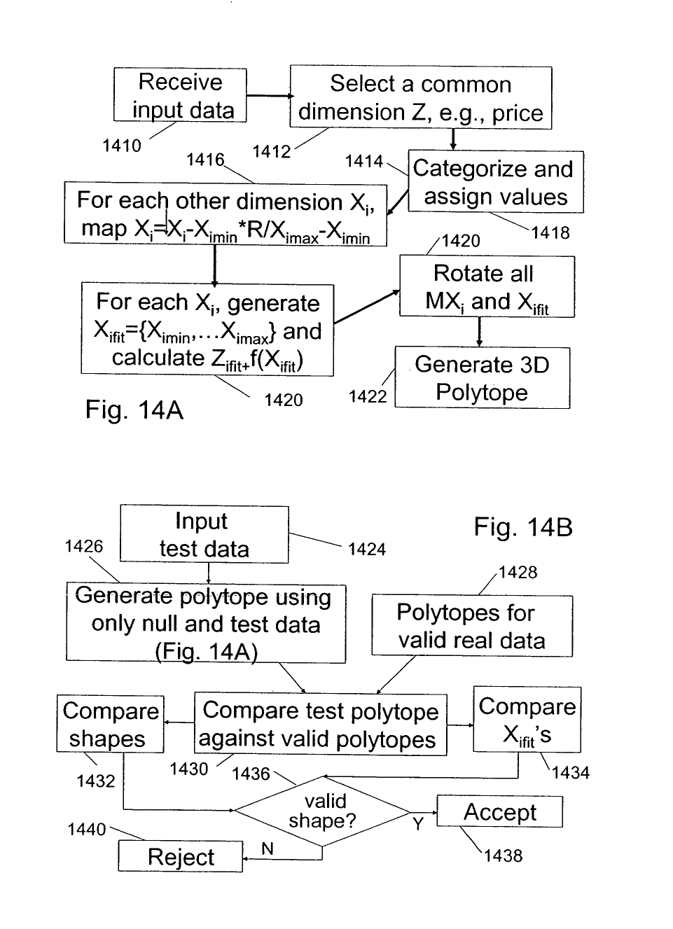

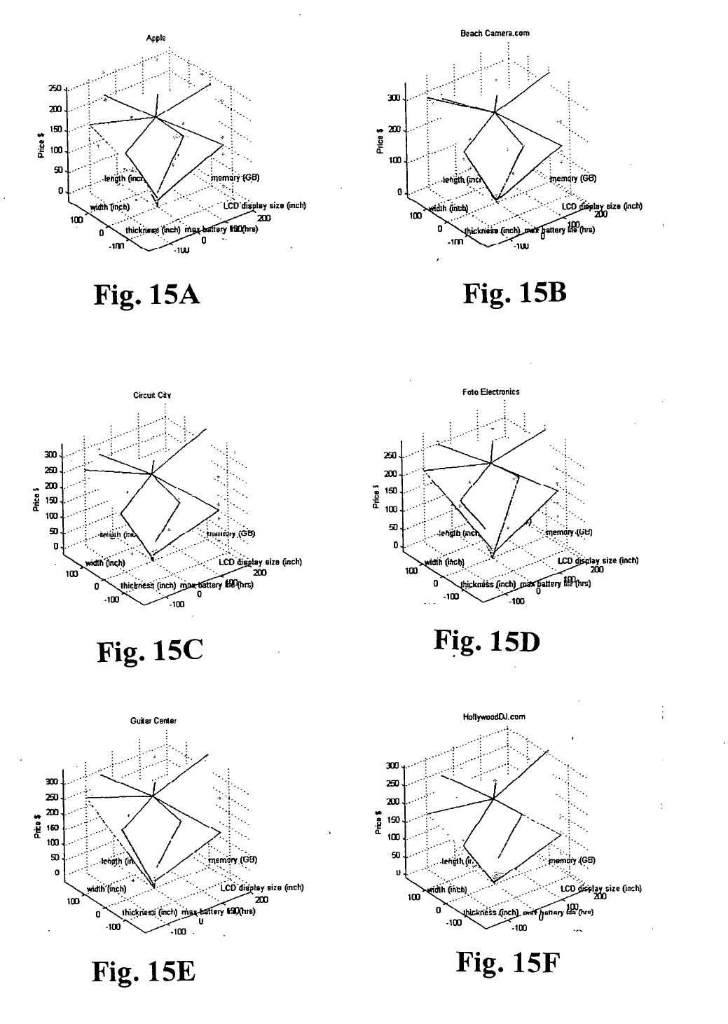

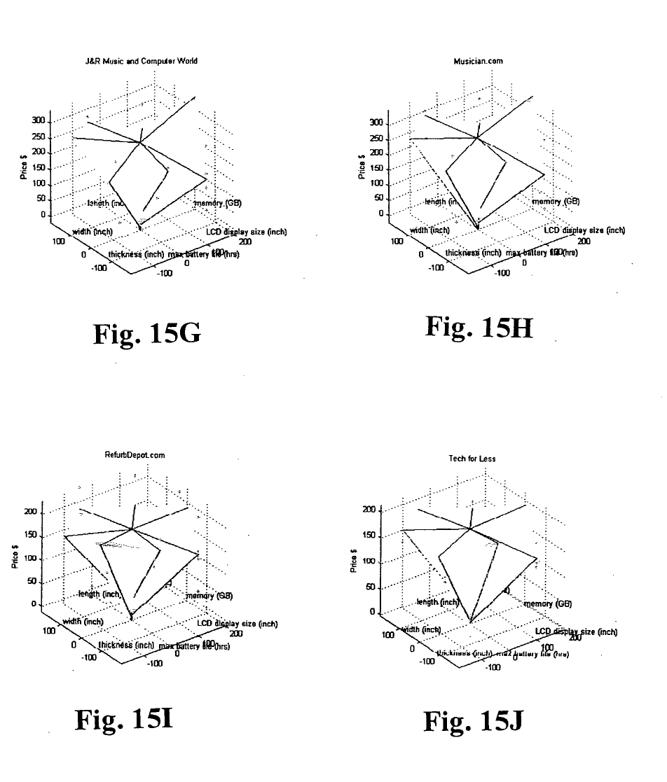

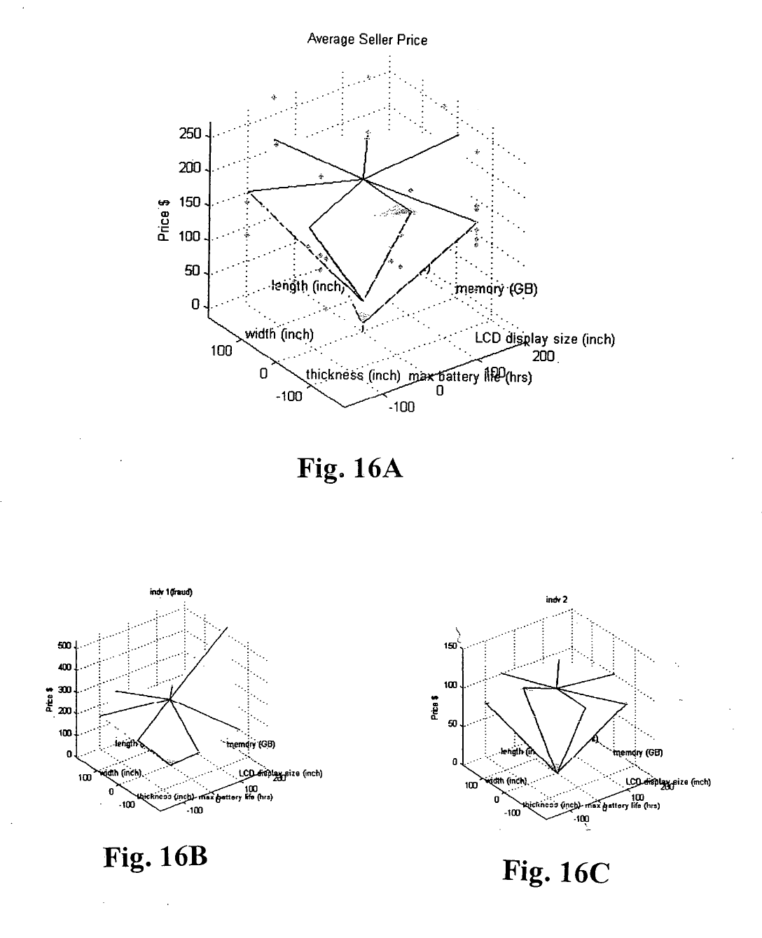

In the example of FIG. 13, input to the polytopic market database 1312 is through the data acquisition engine 1308, as represented by the arrow from the data acquisition engine 1308 to the polytopic market database 1312. In an embodiment, the data acquisition engine 1308 puts raw data in a format that is useful to the trading post. For example, data can be assigned a meaningful relationship with other data enclosed in a data volume (e.g., a polytope), as detailed below in Section B, with respect to FIG. 14A, and FIGS. 15A-15J. The polytope(s) for a collection of known valid goods may be used, as detailed in Section B with respect to FIG. 14B, and FIGS. 16A-16C, to validate whether a new item is fraudulent or suspicious.

The polytopic market database 1312 may include an auction data repository, an alert repository, and/or other repositories that are useful in accomplishing the functionality of the trading post. While the polytopic market database 1312 includes polytopes, non-polytopes could be used in an alternative. Thus, in an alternative, the polytopic market database 1312 can be replaced with a market data database. It may be noted that although the arrow shows input from the data acquisition engine 1308 to the polytopic data market database 1312, in an embodiment, the data acquisition engine 1308 may request data from the polytopic market database 1312 to assist in formatting new data, or for other reasons.

In the example of FIG. 13, the trade recommendation module 1314 receives data from the polytopic market database 1312 to recommend trades for users. Since the trading post includes trading techniques to which users may never have been exposed, the trade recommendation module 1314 may be useful to educate users how to use the novel tools associated with the system 1300. The system 1300 may include “knowledge” about how to maximize profit for a particular type of trade, how to maximize speed with which a trade can be accomplished, how to make hybrid trades, etc. The trade recommendation module 1314 can provide recommendations by considering parameters of a trade input by a user and comparing the parameters to an ideal polytope and/or market data polytopes.

In the example of FIG. 13, the trade assistance module 1316 receives data from the polytopic market database 1312 to assist users with trades. Since users may not be familiar with the trading techniques associated with the system 1300, the trade assistance module 1316 can also be useful to help educate users. Otherwise or in addition, the trade assistance module 1316 can provide market data that is useful to accomplish trades of a type desired by users.

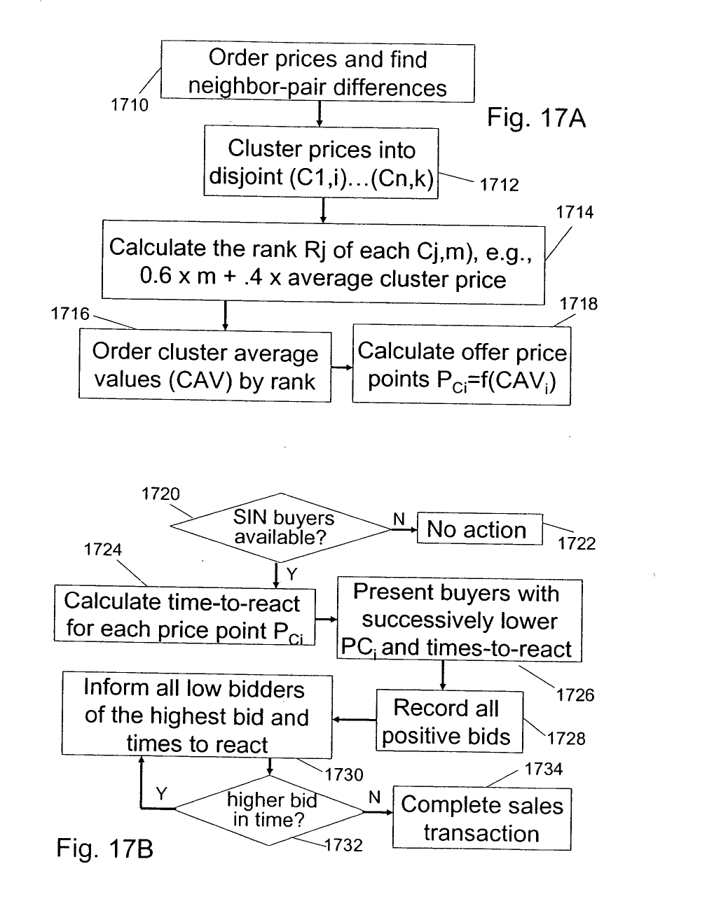

In the example of FIG. 13, the SitN module 1318 receives data from the polytopic market database 1312 to accomplish trades made in a SitN fashion, such as was described by way of example but not limitation previously with reference to FIG. 9, as further detailed in Section C with reference to FIGS. 17A and 17B.

In the example of FIG. 13, the secured trade module 1320 receives data from the polytopic market database 1312 to facilitate making a trade with the requisite security in place. For example, parties to the trade may desire that a transaction go as intended and therefore prefer or demand mechanisms that ensure the trade is accomplished smoothly. In a non-limiting embodiment, the secured trade module 1320 may also provide useful forms, such as bills of lading and the like.

In the example of FIG. 13, the hybrid trade module 1320 receives data from the polytopic market database 1312 to facilitate making hybrid trades. Hybrid trades may include one or more of cash, exchange, option, or other types of trades.

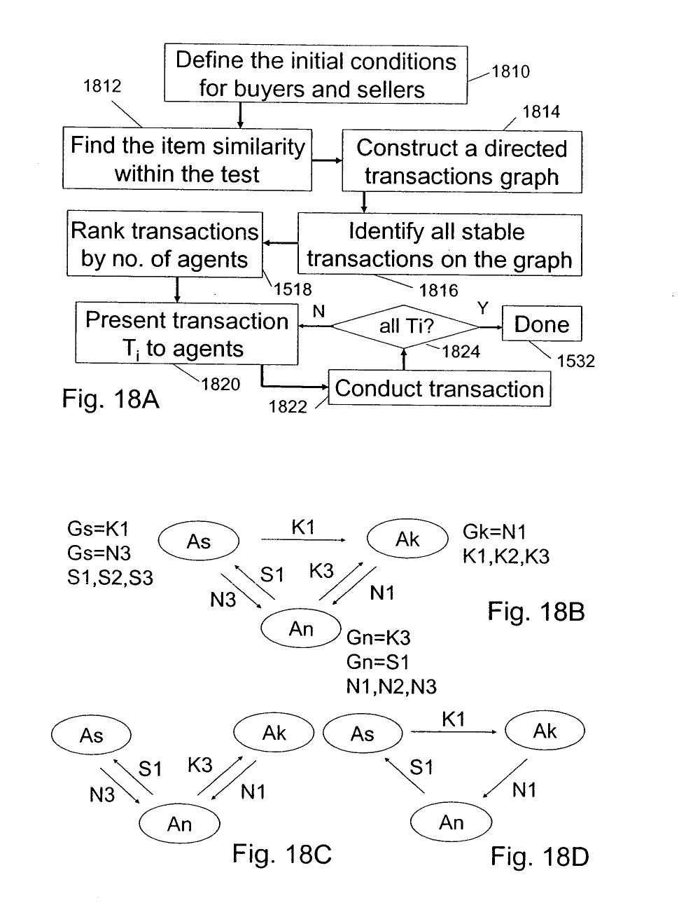

In the example of FIG. 13, the Pareto trade module 1322 receives data from the polytopic market database 1312 to facilitate making trades that are Pareto optimized, whether strongly or weakly. Advantageously, due to the amount of data that is maintained by the system and the organization of the data such that meaningful relationships are formed (by way of, for example, polytopes), rapid trades involving multiple parties can be accomplished. As a simple example, assume a first user wants to buy a first widget, a second user wants to sell a second widget, and a third user wants to trade a first widget for a second widget along with some cash. The system 1300 can, in a cyclical transaction, have the first user give cash to the second user, have the second user send the second widget to the third user, and have the third user send the first widget to the first user. The system 1300 can ensure that the parties receive at least what is expected from the transactions. It may be noted that the operators of the system 1300 need to be able to earn some profit for setting up a trading post such as this. Techniques for obtaining revenue could include skimming some profits from a Pareto trade that still ensures all parties receive a fair share, or by some other known or convenient technique (such as subscription, or advertisement). Details of a Pareto trade with multiple trading agents in given in Section D below with reference to FIGS. 18A-18D.

In the example of FIG. 13, each of the modules 1314-1324, and the polytopic market database 1312, are depicted as sending data to the support engine 1326. The support engine 1326 may include various support modules that would be of use to trading tools and trade security tools.

In the example of FIG. 13, the support engine 1326, the direct trading engine 1328, and the trade security engine 1330 pass data back and forth amongst one another to accomplish trades. The direct trading engine 1328 provides the tools and features that users might expect when dealing with a trading post. Trading techniques to accomplish simple trades, such as those described with reference to FIGS. 3 and 4 by way of example but not limitation, may be made available to users. The support engine 1326 can provide additional, more advanced features. The trade security engine 1330 is coupled to the user interface 1332 to pass input and output with respect to a user in a secure manner. The trade security engine 1330 can authenticate users connecting to the system via the user interface 1332, validate credit card information with a third party, and/or accomplish other known or convenient security measures.

In an embodiment, exchanging of items in closed loops results in efficient one-to-many reach. Using the techniques described herein, exchange cycles can be employed.

In an embodiment, a system employs market basket transactions to pool buyers and sellers from the neighborhood to reduce individual costs of transactions.

In an embodiment, auctions are offered with hybrid bidding (cash, exchange, futures, etc.). Advantageously, this can enable individuals to compete with market-cornering entities.

In an embodiment, price ranges can be offered in alerts for efficient and faster sales.

In an embodiment, sellers are permitted to generate sales alerts without commitment. This can help sellers list and match with a buyer at a future time, but keep the flexibility to negotiate the price at the last minute.

In an embodiment, the system can include secured event authenticated settlement. This allows active participation of the community to settle conflicts related to transactions. The settlement functionality may be optional when both seller and buyer agree to use it. In one implementation, the request for secured event authentication settlement appears as a flag on the buyer or seller.

In an embodiment, the system includes option listing.

In an embodiment, the system includes multiple listing. This allows users of the system to do more in less time.

In an embodiment, the system facilitates searching for items to buy. Advantageously, a potential buyer can enter search terms in a known or convenient format to find sellers of items meeting the search criteria. Similarly, a seller can enter search terms in a known or convenient format to find potential buyer for the product. Using techniques described herein, this type of searching can uncover both immediate matches (e.g., parties associated with alerts with commitment who have made an offer for a particular item), willing negotiators (e.g., parties associated with alerts without commitment who have indicated an interest in a particular item), or those who have had a historical interest (e.g., parties who have lost in bids in prior auctions). Those with historical interest can be offered the item at a price that matches their highest bid, or at some other price. Advantageously, an alert can be generated in much the same manner as a search is generated. So, a party can enter a series of search terms to express their interest in an item, and other parties will see the alert if they match some or all of the search terms associated with the alert. This functionality is represented by way of example but not limitation in FIG. 13.

B. Polytopic Market Data (PMD)

The method presented here is a simple and effective way to visualize multidimensional data, which can help the human eye to detect misclassifications or fraud. The model assumes n number of dimensions, where each dimension is an attribute of feature of an item, e.g., its price, weight, color, condition, internal specifications, and so on. More generally, the attributes can be of four types:
1. Binary (e.g. yes/no, present/absent)
2. Continuous (e.g. price, weight)
3. Categorical (e.g. color, manufacturer, etc)
4. Fuzzy (e.g. condition {damaged, good, new})

A first step in the PMD approach is to establish, for a particular type or class of goods, one or more polytopes for known, valid examples of that good, to provide a polytope reference against which test goods can be compared for “validity.” FIG. 14A shows steps in a method for generating one or more polytopes for a particular type of goods, in this case, goods that are known to be valid. To begin the operation, the system is supplied with input data at 1410, in the form of a number or rating for each attribute of each item used in constructing the polytopes. As an example of the data input, Table 1 below shows various attributes for several models of iPODs, including manufacturer, memory, weight, length, width, thickness, battery life, and display size. The polytope is generated by plotting each of these attributes X against the common dimension Z, typically item price, which is given in Table 2 for several retailers and models of iPODs. With the selection of a common axis, e.g., price, at 1412, and assignment of values to all attributes, at 1414, the program is ready to generate the various equations needed to construct a 3-D polytopic figure.

In one example, each dimension, X (where X¹Zc), is mapped according to the following equation: Xmapped=(X−Xmin)*R/(Xmax−Xmin), as indicated at 1416 in FIG. 14A, where Xmin and Xmax are minimum and maximum values of X. R is an arbitrary number which determines the resolution of the final polytope (e.g. R=100). This is a linear mapping which maps the min value to 0 and the max to 1. Thus the method maps n−1 mapped dimensions (denoted by MXi) and one common dimension (Zc).

In the next step, referred to as linear data fitting, each dimension, Xi, as a function of common dimension, Zc, is fitted to a equation line, f(x), as indicated at 1428. The fitted line is extrapolated at R points between min and max values, e.g., Xfit and Zfit, where Xfit,i={Xi,min . . . Xi,max} and Zfit,i=f(Xfit,i)

Each mapped dimension, MXi is now rotated in the X-Y plane according to the following equations, and as indicated at 1420 in FIG. 14A.
mxi=MXi*COS(i*2p/(n−1))
myi=MXi*SIN(i*2p/(n−1))
i=1 . . . n−1
and the fitted values (Xfit,i's) are also rotated in the same manner:
xfit,i=Xfit,i*COS(i*2p/(n−1))
yfit,i=Xfit,i*SIN(i*2p/(n−1))

The 3-D polytope of the data is generated, at 1422, using the circularly mapped fitted points:
{xfit,i, yfit,i, Zfit,i } i=1 . . . n−1, and the circularly mapped data points, mxi's and myi's, are also plotted as scatter points against the common dimension in the 3D space:

{mxi, myi, Zc} i=1 . . . n−1. FIGS. 15A-15J show polytopes generated from the data in Tables 1 and 2, where the seven rotated dimensions in each plot are the seven attributes (other than manufacturer) given in Table 1, and the ten plots represent the polytope for the product sold by each of the ten retailers in Table 2.

TABLE 1
ipod data

| | iPOD | | | | | | | | |
|---|---|---|---|---|---|---|---|---|---|
| | 1 | 2 | 3 | 4 | 5 | 6 | 7 | 8 | 9 |
| manufacturer | null | Apple | Apple | Apple | Apple | Apple | Apple | Apple | Apple |
| memory (GB) | 0 | 0.512 | 1 | 2 | 4 | 20 | 4 | 30 | 20 |
| weight (oz)) | 0 | 0.78 | 1.5 | 1.5 | 3.6 | 5.6 | 3.68 | 4.8 | 5.6 |
| length (inch) | 0 | 3.3 | 3.5 | 3.5 | 3.6 | 4.1 | 3.6 | 4.1 | 4.1 |
| width (inch) | 0 | 0.98 | 1.6 | 1.6 | 2 | 2.4 | 2 | 2.4 | 2.4 |
| thickness (inch) | 0 | 0.33 | 0.27 | 0.27 | 0.5 | 0.57 | 0.5 | 0.43 | 0.57 |
| max battery life (yrs) | 0 | 12 | 14 | 14 | 18 | 12 | 8 | 14 | 12 |
| LCD display size (inch) | 0 | 0.0 | 1.5 | 1.5 | 1.67 | 2 | 1.67 | 2.5 | 2 |

TABLE 2
Sellers prices

| | iPod # | | | | | | | | |
|---|---|---|---|---|---|---|---|---|---|
| Seller | 1 | 2 | 3 | 4 | 5 | 6 | 7 | 8 | 9 |
| Apple | 0 | $49.00 | $149.00 | $129.00 | 149.00 | nan | nan | $259.00 | $169.00 |
| Beach | 0 | nan | $144.00 | $179.00 | nan | nan | nan | $273.95 | nan |
| Camera.com | | | | | | | | | |
| Circuit City | 0 | $69.99 | $142.49 | $186.99 | nan | nan | nan | $279.99 | nan |
| Foto Electronics | 0 | | $122.70 | $159.10 | $215.90 | nan | $215.9 | nan | $254.75 |
| Guitar Center | 0 | $69.00 | nan | nan | nan | nan | nan | $299.00 | nan |
| HollywoodDJ.com | 0 | $99.99 | nan | nan | $199.99 | nan | nan | nan | nan |
| J&R Music and | 0 | $69.00 | $139.99 | $184.99 | nan | nan | nan | $274.99 | nan |
| Computer World | | | | | | | | | |
| Musician.com | 0 | $69.99 | nan | nan | nan | | nan | $299.00 | nan |
| RefurbDepot.com | 0 | $69.95 | nan | $139.95 | nan | $155.95 | nan | $229.00 | $155.95 |
| Tech for Less | 0 | nan | $124.00 | $133.00 | nan | $170.93 | nan | nan | nan |

To test if a new test item with data D is fraud or not, the procedure above is repeated to create a test polytope, using only the null and D data point, indicated at 1424 in FIG. 14B, to generate the polytope at 1426. The resulting test polytope should be compared with the polytopes generated by valid real data, at shown at 1430 in FIG. 14B. If the shape is awkward then it's probably a fraud. As indicated in FIG. 14B, comparing a test-item polytope with a polytope from valid real goods may be done visually, at 1432, by comparing the two polytope shapes, or mathematically, by comparing the ranges of the fitted attribute equations X_{ifit}, as at 1434. In the former case, the shapes may be compared by human observation, or using known pattern recognition software to analyze differences between the two shapes. For the mathematical approach, the range of each fitted attribute equations for the test object is compared against that for the corresponding attribute in the “standardized” polytope.

In either approach, if one of the attributes of the test is outside the normal limits, the test item can be readily identified as fraudulent or otherwise suspicious. As an example, Table 3 below shows 2 items being sold by individual sellers, one of which is offering fraudulent goods.

TABLE 3
Individual sellers (one of which is fraud)

| iPOD Seller | indv1 | indv2 |
|---|---|---|
| manufacturer | Apple | Apple |
| memory (GB) | 10 | 20 |
| weight (oz) | 2.1 | 5.6 |
| length (inch) | 4.1 | 4.1 |
| width (inch) | 2 | 2.4 |
| thickness (inch) | 0.44 | 0.57 |
| max battery life (hrs) | 14 | 12 |
| LCD display size (inch) | 2.5 | 2 |
| Price (USD) | $100 | $199 |

The example of FIG. 16A shows the averaged 3-D polytope assembled from the polytopes of FIGS. 15A-15J. This figure will be used as the item standard for detecting fraudulent goods. FIG. 16B shows the polytope for the fraudulent item in the example above. As can be seen, this test polytope has a severe anomaly in one of its attributes (the attribute of item memory, which fails to match any of the memory values of known iPODs), thus producing an easily recognized shape mismatch. The item whose polytope is represented in FIG. 16C, on the other hand, has a close shape match with the “standardized” polytope, indicating a valid test item.

C. Sell-It-Now Trading Algorithm

Step 1: This feature of the invention will be described with reference to FIGS. 17A and 17B, and is employed in the system to optimize bidding for items among multiple potential traders. In the method, assume p1, p2, . . . pM are various price points available for an Item of type1 at time t1. The unique users/past bidders are: u1,u2,u3, . . . uM such that p1>p2>p3>. . . >Pm

Step 2: The system orders the prices and calculates the difference in adjacent ordered price pairs, e.g., p2−p1=d1; p3−p2=d2; . . . pM−pM−1=dM−1. Steps 1 and 2 are indicated at 1710 in FIG. 17A.

Step 3: The items are then clustered by price, at 1712, e.g., using the logic: If d2>=0.9 d1 and d2<=d1 then classify (p1,p2,p3, . . . pk) as equidistant cluster C1.

In step 4, identify the disjoint price point pf, at pf Step 2. such that pf+1−pf=df; pf+2−pf+1=df+1; . . . pM−pM−1=dM−1; using the above classification method to classify equidistant cluster C2.

In Step 5, check for any more price points left in the list. If YES, go to Step 4. If NO, go to Step 6. (Steps 3-5 are indicated at 1812 in FIG. 17A.

Step 6. List all the equidistant Clusters (C1,n1), (C2,n2) . . . (Ci,ni), and rank the clusters in price P={Cr1,Cr2, . . . Cri}; such that rank=A. nz|z=(1, . . . m)+B. (X_z)|z=(1, . . . m); where A=weight of number of total buyers in cluster Cz=0.6 or 0.5; B=weight of average price of the Cluster Cz=0.4 or 0.5; Thus, P={Cr1,Cr2, . . . Cri} implies R1>R2>R3>. . . >Ri;

This step is shown at 1714, where A is assigned the value 0.6 and B, the value 0.4. Step 7: The cluster average value (CAV), i.e., the average value of all items within a disjoint cluster, is then ranked at 1716, according to the ranking at 1714, and this ranking is used in calculating offer price points P as a function of CAV, as indicated at 1718.

Step 8: To initiate the bidding, the program confirms that SIN buyers are available, at 1720 in FIG. 17B. The bids that are sent to traders (or buyers) will be based on the ranked price points calculated above, and calculated time-to-react values, which will indicate to each trader, the offered price, and time to react to that price. In general, the lower the offered price, the less time to react. As will be seen in the example below, this will encourage traders to initiate the trading and encourage upward price bidding. The prices and times-to-react are iterated upwards until a SIN trader comes into the range of possible trade completion.

The logic proceeds as follows:
Check distance<=threshold.
Set X_ri=pA; as it represents Ci as it contains price points>=p1,p2, . . . and so on;
pA−0.05pA=Px.

Step 9: Present Px to SIN trader; and check Px<=Pn; If YES: ACCEPT AS POSSIBLE TRADE. If NO: select X_ri−1 (X_ri−1>X_ri)=pA; and repeat this If NO and S.nextelement( )=NULL then: DO NOT ACCEPT THE TRADE. If YES and Px=X_j−0.05 X_j; corresponding to cluster Cj: ACCEPT AS POSSIBLE TRADE. And display the probability of the trade completion.

Step 10: with Px enter negotiation in Cr1; such that Cr1=(pr1,pr2,pr3, . . . prn); exclude all clusters less than X_j, belonging to P.
for (ur1,pr1)→set Px=pr2+((pr2−pr1)/2); Px<pr1; while Px>X_j (ur2,pr2)→set Px=pr3+((pr3−pr2)/2); Px<pr2; while Px>X_j (ur3,pr3)→set Px=pr4+((pr4−pr3)/2); Px<pr3; while Px>X_j
   when prk<X_j then : set Px=prk+((prk-1−prk)/2); Px>prk; while Px<X_j.

Step 11: The time-to-react that is presented with the price points is calculated as, for example, 1/A times the price point+30 minutes, where A is a depended on (with the given percentages):
Number of total interested buyers; =33%
Market condition (+/−)=25% (1, . . . 0)
Diff1 (Relative Value of the trade)=Px−past historical average of 10 trades on this itemtype; =20%
Diff2 (Relative value of the trade to the highest historical value of the trade done in the market; 10%
Probability of the trade completion=−5%.
Present Bollinger band condition On the asset price (squeeze 0/expansion 1)=16% Total number of buyers present in the entire market across all the items=1%)

This calculation is illustrated at 1724 in FIG. 17B. The price points and time-to-react are then presented to buyers with successively lower price points and times to react, as at 1726, as follows: Present (Px, Yur1), (Px,Yr2), . . . and so on.

Step 12. The program then checks if Px is accepted by any buyer (box 1728 in FIG. 17B). If not, it sets pr1=Px;pr2=Px; and returns to step 9.

Step 13: if Px is accepted then it is SOLD to the first buyer accepting the terms per step 10. If Px is not accepted and Px-X_r2 crossed the threshold of closeness, then OPEN negotiation in Cluster Cr2. GOTO step 9.

Do till Px is accepted, while P.next element( )=NOT NULL; if Px is not accepted and P.next element ( )=NULL then return: ITEM CANNOT BE SOLD AT THIS MOMENT, WE WILL KEEP THIS AS AN ALERT FOR (10 or H) DAYS IN OUR DATABASE.

Step 14: In case of a tie inform ALL the buyers but except the top paying buyer to exceed the price of the present top paying buyer. If new buyer=NULL then SOLD to present top buyer; else SOLD to new top buyer.

Step 15: From steps 13 and 14 the item is SOLD (hard asset shorting); with Px=SOLD; buyer enters into escrow with the MM and with Px=SOLD; present Px=Px−(0.05 or max number) Px; Px<Pn; iterate till Px=Pn;: ACCEPT TRADE AS GUARANTEED. This algorithm also assumes that the SIN trader at Step 9 gets into Escrow with MM and the potential buyer with amount Px=Px+(0.V).Px; V={factor dependent on the SIN traders, past and or present credit profile with MM}=(0, . . . , 999). Match buyer with SIN trader (shipping information and so on); CONGRATULATE SIN trader and buyer.

In summary, the SIN algorithm (i) shows the cluster classification and ranking, (ii) a negotiation starts with one or more SIN traders to bring the trader to trade vicinity by selecting and offering progressively higher average cluster price, and (iii) the MM negotiates with buyers with all the clusters ranked from in decreasing order of the set up to the cluster where the average price got accepted. If a better price can be found on higher clusters, the better price is offered to the SIN trader. The algorithm is based on a trading concept called shorting.

The example below will illustrate the method. Assume the price points are as follows:
1,3,4,5,7,9,11,12,13,14,15,17,25,30. and N=14.
D1=3−1=2; D2=4−3=1; and so on such that
D3=1; D4=2; D5=2; D6=2; D7=1; D8=1; D9=1; D10=1; D11=2; D12=8; and D13=5;
Based on that these prices, the price points are all classified, as follows.
(C1,1),(C2,3),(C 3,8),(C4,1), . . . (C5,1).
The rank of each clusters: is calculated as:
   R1=0.6×1+0.4×1=1;
   R2=0.6×3+0.4×4=3.4;
   R3=0.6×8+0.4×12.25=9.7
   R4=0.6×1+0.4×25=10.6
   R5=0.6×1+0.4×30=12.6
Arranging P={C5, C4, C3, C2, C1};
S={30, 25, 12.25, 4, 1};
Let us say SIN trader takes trade @ 11.00 from step 8.
Exclude clusters C1, C2 as lowly clusters.
First enter negotiation in cluster C5 and offer 29.5,

$$\begin{matrix}Calculate Time to react , Y = 1 / A \times Px + 30 ; \\ = ( 1 / 0.577 ) \times 29.5 + 30 \\ = 81.13 Minutes .\end{matrix}$$
Present the top buyer with 30 historical info, (29.5, 81.13)
At the same time calculate for second top buyer with 25 historical info, (24.5, 72.46)
And also in cluster C3 present Buyer 7 with price (11.60, 50.10)
   Buyer 9 with price (11.60, 50.10)
   Buyer 11 with price (11.60, 50.10)
   Buyer 12 with price (12.5, 51.67)
   Buyer 13 with price (13.5, 53.39)
   Buyer 14 with price (14.5, 55.13)
   Buyer 15 with price (16, 57.73)
   Buyer 17 with price (21, 66.39)
Assume a positive response is received from 3 buyers @ 24.5
Buyer @ 14.5, Buyer @ 16.
Inform Buyer @14.5 and Buyer @16 to exceed 24.5 at this moment. To buy it now (BIN), assume Buyer @ 14.5 exceeds 24.5 and comes to 24.80. Inform buyers at 16 and 24.5 that a new buyer is available at 24.80. Say buyer @ 24.5 comes again in time to react at 24.85, do this step again and determine new buyer. Assume that the new buyer is at 24.85, and no one left in the sight. Then return SOLD @ 24.85. Calculate the Buying price from the SIN Trader=23.61. or buy it @ 22: ACCEPT GUARANTEED TRADE, giving nice 100% positive surprise on guaranteed trade settlement over 11 as initially asked by the SIN trader. The MM arbitrage=2.85—1.25 where every SIN trader finally settles the price much above his/her initial expectation. This is the beauty of SIN trading minimum asked is guaranteed and +% surprise.

$$The Calculation of A = 0.33 \times ( say 0.6 ) + 0.25 \times ( say 0.4 ) + 0.20 \times ( say 0.8 ) + 0.10 \times ( say 0.3 ) - 0.05 \times ( say 0.5 ) + 0.16 \times ( say 0.7 ) + 0.01 \times ( say 0.2 ) ;$$

C. Pareto Sale with Multiple Agents

This algorithm is shown illustrated in FIGS. 18A and 18B, and covered in claims 12-17. Let us say in any point of time we have 3 agents As, Ak, and An, where (as shown in FIGS. 18A), As is offering Gs and wants to get according to preference S1, S2, S3, S4, represented as As(Gs| S1, S2, S3, S4) Similarly for other agents as follows: Ak(Gk| K1, K2, K3); An(Gn| N1, N2, N3, N4). These representations define the initial conditions for the buyers and sellers (traders) in the system, as indicated at 1610 in FIG. 18A.

The system then finds the item similarity among the goods being traded, i.e., goods that will represent reasonable exchanges to the traders, as at 1912 in FIG. 18A. Assume in the example, that the following represent reasonable exchanges. A=K1; Gn=K3; Gs=N3; Gk=N1; Gn=S1; Gs=K1=N3; Gn=K3=S1; Gk=N1;

To solve this transaction by allocating a maximum number of traders, the system constructs a directed transaction graph, as shown in FIG. 18B, that indicates every possible trade of goods between and among traders.

In the next step, indicated at 1816 in FIG. 18A, the system identifies all stable transactions on the graph, where a stable transaction means that a trader gets as much as he receives. Ideally, the stable transaction should involve as many different traders as possible, to promote a maximum exchange of goods. In the example illustrated in FIG. 18A, there are two stable transactions involving all three traders in the example. In the first, shown in FIG. 18C, four items are traded among three agents. In the second stable transaction, shown in FIG. 18D, three items are traded among three traders. Similarly, the graph at FIG. 18C shows two stable trades involving two good among two traders each.

The transactions may be ranked by number of agents involved and/or the total number of goods that may be exchanged, at 1518 in FIG. 18A, and these are then presented to the system players, in order of rankings, at 1820. The system thus cycles through the various transactions, at 1824, until all have been offered, as indicated at 1822 and 1832, respectively. It will be appreciated that at each stable transaction, not all possible goods will be traded, and the untraded goods may be placed back in the trading category, to be used in calculating a new directed transaction graph, and reiterating the trading steps discussed above.

D. Buy, Sell, and Trade Alerts

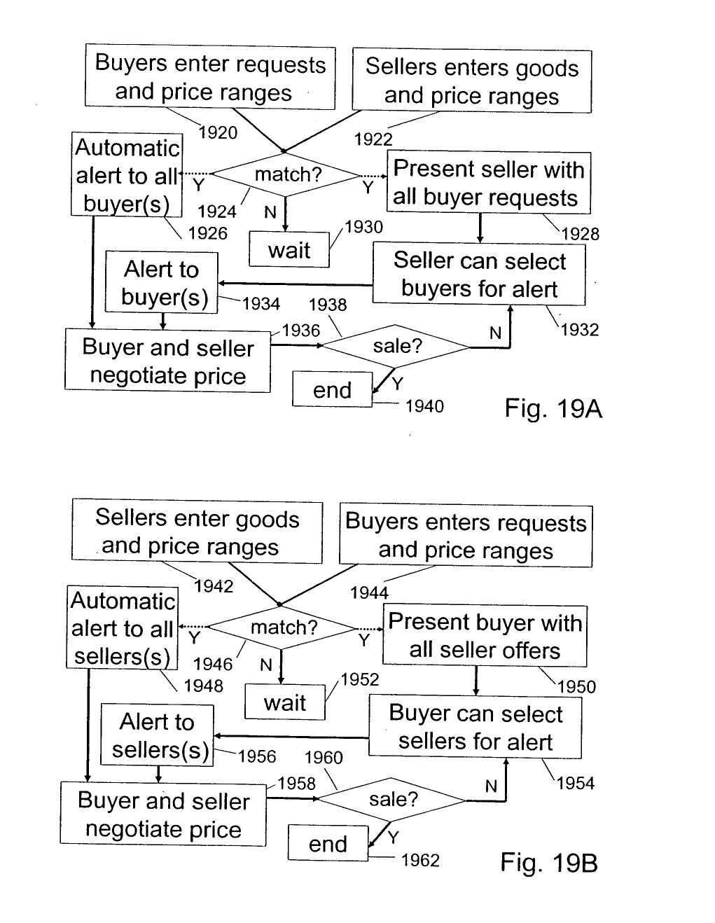

The system provides buy, sell and trade alerts to sellers, buyers, and traders in the system, for promoting buying, selling and trading opportunities to the system users. The Alert system, as it applied to sellers and more generally, to seller or trader offerers, is illustrated in FIG. 19A. In the examples below, the term buyer is intended to encompass both buyers and traders wishing to acquire goods (also acquirers), and the term seller is intended to encompass both sellers and traders wishing to offer goods for sale or trade (also, offerers). The term sale is intended to encompass both a for-money sale or an item-for-item trade.

Sell alerts allow the creator (seller) to create an alert by providing the good(s) details and the price range (or goods) they are willing to accept to complete the sale or trade. Based on the alert criteria, the system will send notifications to the seller about potential buyers by mapping their buy alerts with the sellers sell alert. Sellers can then decide to communicate with the buyer and complete the trade. Sell alerts provide a non-obligatory way by which the sellers can gauge the interest of the buyers for their goods based on the sales criteria.

In the flow chart shown in FIG. 19A, buyers wishing to acquire certain goods, will input the goods to buy or trade, including all pertinent attribute information, and a price range for the goods, at 1920, and this information is stored in the system. When a seller enters an offer on those goods, and specifies a price range, at 1922, the system will attempt to match the seller goods with a stored buyer request, at 1924. If no price match is found, the system simply waits for a new offer, at 1930. If a price match is found, the system may take one of two actions. First, as shown at 1928, the system may present the seller with a Seller Alert with the information on all buyers whose buy or trade information is stored in the system, at 1928. The seller can then select those buyers that he/she wishes to contact, at 1932, and then send a Buyer Alert to those selected buyers, at 1934. In the alternative, a Buyer Alert may be sent to all “qualified” buyers, at 1926. In either case, the group of alerted buyers then can negotiate a price with the seller and/or enter into bidding for the offered goods, at 1936. If no sales or trade is completed, at 1938, the system can either wait for new buyers, or notify the seller(s) to contact a different group of buyers, as indicated in the figure. The process ends, at 1940, when all items being offered are sold or traded.

As can be appreciated, this focused buy advertising allows the seller to send notification of good(s) availability to one or more buyers at the time of creating a sell order. Buyers will be displayed by the system based on the listed good(s) details and the price range entered by the seller. The seller can then select one or more buyers to send a notification. The system provides an option to the seller either to send auto notification to all buyers that meet the sale criteria or they can selectively send notifications to the selected buyers based on their buy alerts. The system will display the buyers based on their inclination/chance to buy goods.

Sell Alerts allows the creator to set up an alert by providing details of the good(s) they want to purchase and a price range they are willing to pay for the good(s). When a sell alert criteria is met, the system sends a notification to the alert creator about the availability of good(s) that met the buying criteria. This feature of the system is illustrated in FIG. 19B. In the flow chart shown here, sellers wishing to sell or trade certain goods, will input the goods to sell or trade, including all pertinent attribute information, and a price range for the goods, at 1942, and this information is stored in the system. When a buyer enters a request for those goods, and specifies a price range, at 1944, the system will attempt to match the acquirer request with a stored offerer goods, at 1946. If no price match is found, the system simply waits for a new buy request, at 1952. If a price match is found, the system may take one of two actions. First, as shown at 1950, the system may present the buyer with a Buyer Alert with the information on all sellers whose sell or trade information is stored in the system, at 1950. The buyer can then select those sellers that he/she wishes to contact, at 1954, and then send a Sell Alert to those selected buyers, at 1956. In the alternative, a Sell Alert may be sent to all sellers, at 1948. In either case, the group of alerted sellers can then negotiate a price with the buyer, and/or enter into bidding with other sellers with the buyers, at 1936. If no sales or trade is completed, at 1960, the system can either wait for new sellers, or notify the buyers to contact a different group of sellers, as indicated in the figure. The process ends, at 1962, when all items being offered are sold or traded.

Focused sell advertising allows the sellers to send notification of good(s) availability to one or more buyers at the time of creating a sell order. Buyers will be displayed by the system based on the listed good(s) details and the price range entered by the seller. Seller, then can select one or more buyers to send a notification. System provides an option to the seller either to send auto notification to all buyers that meet the sale criteria or they can selectively send notifications to the selected buyers based on their buy alerts. System will display the buyers based on their inclination/chance to buy goods, and 9 esobuyers. Buy Alerts allows the creator to set up an alert by providing details of the good(s) they want to purchase and a price range they are willing to pay for the good(s). When a buy alert criteria is met, the system sends a notification to the alert creator about the availability of good(s) that met the buying criteria.

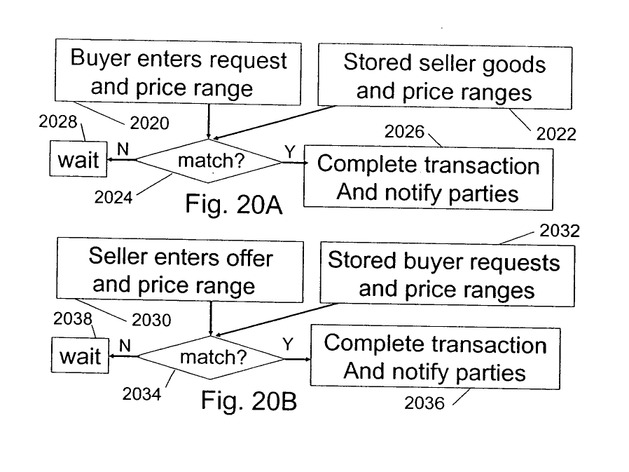

AutoBuy, a feature of the system illustrated in FIGS. 20A allows the users to specify the details of the good(s) they are willing to buy and a price range that the buyer is willing to pay, indicated at 2020 and 2022. Based on the details provided by the buyer, the system will automatically complete the sale by matching a similar sell order that meets the buy order, at 2024 and 2026. As can be appreciated this system creates focused sell advertising where the system will show the list of sellers to the buyer after they create a buy alert. Sellers are selected for display using a criteria based on their inclination/chance of selling. Buyers can then select one or more sellers to send notification about their interest in buying the good(s). System provides an option to the buyer either to send auto notification to all sellers that meet the buy criteria or they can selectively send notifications to the selected sellers based on their sell alerts.

Auto Sell, illustrated at FIG. 20B, allows the users to specify the details of the good(s) they are willing to sell and a price range that the seller is willing to accept, at 2030 and 2032. Based on the details provided by the seller, system will automatically complete the sale by matching a similar buy order that meets the sell order criteria, as indicated at 2034 and 2036

E. Additional Features in the System:

E1. Exchange Bidding to Hedge the Cash Bet.

To leverage the trade terminators value proposition on the asset they are targeting, the trader can use his asset/assets to entice the trade initiator to abandon a high cash bid. For example, assume that somebody lists an iPod for sale of particular description As: iPod (description color, attributes . . . ), Price P1. This side of the trade will be called as Trade initiator and after a choice is validated, e.g., cash bid only or hybrid bid or exchange bid, the potential trade terminators will bid on the listing by cash bid and/or exchange bid. In the exchange bid the same potential trade terminator can list more than one item and declares its value in dollar terms to the MM(market maker-geoemporia).

The MM then decides whether this bidding needs or does not need any security deposit based on the historical performance of the trader. If no history available then security deposit becomes essential (percentage again depends on data from third party like experian, transunion, and so on). Once the bid is listed, the MM waits till expiry or until the seller decides to close the trade by taking either the highest cash bid or at least one of the exchange bids on the list.

So, in the iPod listing example, the trade initiator can exchange for Listings like another ipod, A cellphone, or anything he thinks suitable, or he can decide not to take the exchange at all instead take the highest cash bid. During the seller's listing the MM can ask for what exchanges will be most interesting to him.

So when the buyers/potential TT are listing their exchanges, the MM can suggest items to them and the list later can be trained to use a classified list (which will be a neural net engine+seller's listing=suggestions).

Once the trade Initiator (TI) comes into the market place and chooses the e Hybrid Sale design of his trade, he cannot back down from ACCEPTING at least one offer On or before the expiration set by TI.

E2. Escrow Settlement and Secure Settlement for SIN Trading

If the escrow is P1 then seller puts P1 in the account and buyer puts (P2/2)+P2. Once the escrow a/c gets that automated certification from the MM. The seller needs to ship the item within 4 days of the certification alert, and passes on the shipping no to the MM, so MM makes an check with the shipping agency and can track the delivery receipt, After the delivery is accepted the buyer has 2 days to indicate to MM that the item is Good/Bad. If good: Buyer gets his P2/2 back; Seller gets P1+P2−0.045P2(MM com) a/c is closed. If bad: Buyer should ship back the item

Buyer indicates the MM that item is not acceptable and will require P3 to ship. Seller Pays P3 to the escrow a/c. Once the funds are transferred, MM certifies the return and buyer ships back the item and passes the shipment number to MM, MM checks/tracks and monitors the delivery receipt by the seller. Once done so seller has 2 days to respond and verify the receipt of the return. A/c is settled as buyer gets back P2+(P2/2)+P3, and seller gets back P1−0.045P1. If no response from the buyer: after 2 days, seller gets his P1+P2−0.045P2 and buyer gets his P2/2, but cannot return.

If no response from the buyer during the return process: after 2 days after certification, seller gets P1+P2−0.045P2+P3, and buyer gets P2/2. If no response from the seller after 2 days of after delivery verification: seller gets P1−0.045P1 and buyer gets P2/2+P3+P2.a/c closed. The 4.5% should cover the third party payment system also So MM cut is >4.5% of the final seller payment transaction.

E3. Optimized Keyword Bidding Stratagem

Marketing and focused advertising on the search engine by tracking the N most number of words listed on open trades from both Trade initiation and Trade termination and then buying the words on a search engine based on automatic generation of bid value for the words.

Experiment:
Aim: To see the effect of keyword ranking on a site and then buying the keywords on a search engine based on the auto generation of bid values by comparing the historical word bid data on that particular search engine.

Apparatus: A listing site www.abc.com
A search engine www.google.com
A validating search engine www.yahoo.com
An Algorithm to rank the words in www.abc.com
Based on the number of occurrences and ascertaining a
Bid value by comparing the historical prices of the
Most popular words in www.qoogle.com and determining
Popularity of the ranked words of www.abc.com

Working Principle:

Let us say these following words appear this many times in www.abc.com as follows:

| Words | Occurrences |
|---|---|
| W1 | N1 |
| W2 | N2 |
| — | — |
| — | — |
| — | — |
| — | — |
| — | — |
| — | — |
| Wn | Nn |

Now let us determine the rank chart of the above word list

As follows:

| Words | Occurrences |
|---|---|
| Wn − 1 | Nn − 1 |
| W5 | N5 |
| — | — |
| — | — |
| — | — |
| — | — |
| — | — |
| W1 | N1 |
| W9 | N9 |

Ranked per the chart Wn-1 is the rank one word on www.abc.com and W9 is the lowest ranking word on the site.
Now by collecting the data from the target search engine
First case: www.google.com
By checking the bid price per click for the most popular word
Based on ranking in the google zeitgeist data and knowing the
Value of the bid amount on the corresponding words in the list.

So we get this copy of the zeitgeist data as follows:

| Words | Prevailing price |
|---|---|
| W′1 | P1 |
| W′2 | P2 |
| — | — |
| — | — |
| — | — |
| — | — |
| — | — |
| — | — |
| W′N | Pn |

Now we generate a chart for ranking of the words in the google Zeitgeist data superimposed on the rank chart of www.abc.com

As follows:

| Rank | Zeitgeist word | Rank chart of //abc.com | abc.com// word |
|---|---|---|---|
| 3 | W′3 = | 9 | =W1 |
| 7 | W′7 = | 2 | =W5 |
| — | — | — | — |
| — | — | — | — |
| 9 | W′9 = | 1 | =Wn − 1 |

The new chart showing the new ranks of www.abc.com words relative to www.google.com words is:
Force vector on words from google.com is assumed to be moving in the Opposite direction than the abc.com words.
The new rank is calculated by the following formula:
The New Rank of (abc.com words relative to google.com words)
=Rank of abc.com words−Rank of google.com words
So the in the first row W1 gets a rank of 9−3=|6|=6
And Wn-1 gets a rank of 1−9=|−8|=8

Based on this simple calculation an updated Rank chart is created as follows

| | | Bid price assign |
|---|---|---|
| Words | Rank | per zeitgeist data |
| W1 | 6 | P6 |
| W5 | 5 | P5 |
| — | — | — |
| — | — | — |
| — | — | — |
| Wn − 1 | 8 | P8 |

As used herein, the term “embodiment” means an embodiment that serves to illustrate by way of example but not limitation.

As used herein, the term “item” may be defined to include any good or service (including an activity, event, or occurrence) that may be listed in a catalog, online, or in any other form. An item may include characteristics that may be used to categorize the item. An item may match another item if the characteristics of the items are similar. The match need not be an exact match. Rather, a match may be an indication of a relative degree of similarity or an absolute degree of similarity, or a degree of relatedness. The absolute degree of similarity may indicate belonging to a same category (e.g., a “food” category), same characteristic (e.g., costing over a certain amount of money), or other relationship (e.g., ink is related to printers). Matched items are considered to be related items.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

It is claimed:

1. A method for reducing the risk of having inferior or fraudulent items being offered and sold in an on-line auction system for selling or exchanging items of goods between sellers and buyers, comprising
(a) for a given type or class of goods, constructing a polytopic representation for a group of known valid items of the given type or class, in which each of a number of attributes of the goods are plotted as a function of a common attribute, and the set of all attribute plots are assembled to form a composite polytopic figure,
(b) for a new test item within such type or class of goods, constructing a polytopic representation of the item,
(c) comparing the polytopic representation of the test item against the polytopic representation of the known valid goods, to determine if each of the test-item attributes falls within an acceptable attribute range for the known valid goods, and
(d) if the attribute properties of the test item are within the acceptable attribute ranges of the known valid goods, the item is accepted for sale or trade, and otherwise rejected.

2. The method of claim 1, wherein the common attribute employed in step (a) is the price of the goods, and other attributes of the goods that are plotted against price include at least three attributes selected from the group related to (i) the condition of the goods, (ii) features that contribute to the performance or utility of the goods, and (iii) features that contribute to buyer appeal.

3. The method of claim 1, wherein the polytopic representations constructed in steps (a) and (b) are formed by rotating each attribute plot about the common-attribute axis, to form a 3-D multi-faceted solid, and said comparing step (c) includes visually comparing the two polytopic representation visually or using pattern recognition.

4. The method of claim 1, wherein any test item accepted in step (d) is added to the goods used in calculating a known valid polytopic representation of the goods in step (a).

5. Computer-readable code embedded in a machine-readable medium, operable to direct the operation of a computer for use in carrying out steps (a)-(d) of claim 1.

6. An on-line auction system for selling or exchanging items of goods between sellers and buyers, comprising
a website,
a database for storing, for each of at least some of the goods being offered or traded on the website, a polytopic representation for a group of known valid items of that good, in which each of a number of attributes of the goods are plotted as a function of a common attribute, and the set of all attribute plots are assembled to form a composite polytopic figure, and
computational means for constructing such a polytopic representation of a test item within such type or class of goods,
wherein, by comparing the polytopic representation of the test item against the polytopic representation of the known valid goods of the same type, it can be determined whether the test-item attributes fall within an acceptable attribute ranges for known valid goods of that type.

7. A method for promoting sell-it-now (SIN) buyer-bidding activity in an on-line auction system in which a plurality of goods of a given type are available for sale, and a plurality of potential on-line buyers have been identified, said method comprising
(a) ordering the goods into a plurality of price-range clusters,
(b) calculating time-to-react values for the goods in each cluster, based on the price of the goods,
(c) identifying potential buyers and amounts the buyers have indicated they might pay for goods of the given type,
(d). sending to a plurality of potential buyers, an offer for sale identifying the item(s) for sale, a quoted price related to the cluster price, time-to-react values, and optionally, historical information about the sale of similar goods in the quoted price range, where different potential buyers are sent different quoted prices and time-to-react values,
(e) recording the top “buy” bid from a potential buyer submitted within the indicated time-to-react,
(f) alerting the other potential buyers of the top bid, along with a given time-to-react, and
(g) repeating steps (e) and (f until a final top bid is accepted.

8. The method of claim 7, which further includes repeating steps (d) through (g) for remaining, unsold goods within the cluster.

9. The method of claim 7, wherein the cluster prices are disjoint, and the items in the clusters are ranked for order of presentation to potential buyers as a function of cluster price and quantity of goods within a cluster.

10. The method of claim 7, wherein the time to-react values are calculated as the product of a factor that is calculated as an inverse function of (i) the total number of interested buyers and (ii) the difference between the offered price and a historical average and/or highest historical value for that type of goods, times the offered price.

11. Computer-readable code embedded in a machine-readable medium, operable to direct the operation of a computer for use in carrying out steps (a)-(g) of claim 7.

12. A method for coordinating the trading of goods between multiple traders in an on-line trading system, comprising
(a) identifying, for each such trader, the goods that trader has to offer and the goods the trader wishes to acquire,
(b) identifying the item similarity between those that are being offered and those that a trader wishes to acquire,
(c) identifying, from among all of the possible item exchanges between and among traders, (i) all stable transactions in which each trader gives and receives a comparable number of items, and (ii) the number of traders involved in each stable transaction, and
(d) for at least one of the stable transactions identified in step (c), presenting each trader with names of items that the trader will be exchanging in the transaction.

13. The method of claim 12, wherein step (c) includes constructing a directed graph showing all traders as nodes and the possible items of trade between each pair of traders as connection between nodes, and identifying on the graph, all subgraphs in which each trader gives and receives a comparable number of items.

14. The method of claim 12, wherein the stable transactions are presented to the traders substantially in the order of total number of traders involved.

15. The method of claim 12, wherein the stable transactions are presented to the traders in substantially in the order of total number of items that may be traded in the transaction

16. The method of claim 12, which includes, after receiving acceptance or rejection of the proposed trade from the traders, confirming whether the transaction is still a stable one, and if it is, completing the transaction between and among all of the consenting traders.

17. Computer-readable code embedded in a machine-readable medium, operable to direct the operation of a computer for use in carrying out steps (a)-(g) of claim 12.

18. A method for method for alerting buyers, sellers, or traders in an on-line auction system to selling, buying, or trading opportunities, comprising
(a) storing information relating to a seller or trader offerer, the goods the offerer wishes to sell or trade, and a transaction price range for the goods,
(b) storing information relating to a buyer or trader acquirer, the goods the acquirer wishes to buy or trade, respectively, and a transaction price range for the goods,
(c) for a selected goods, matching one or more offerer price ranges with one or acquirer price ranges or goods, and
(d) when an overlapping price range is found in step (c), carrying out one of the following steps:
(i) alerting one or more offerers to the existence of all price-matched acquirer requests,
(ii) alerting one or more acquirers to the existence of all price-matched offerer goods,
(iii), both steps (i) and (ii), and
(iv) completed a sale or trade for a matched-price item or items between an offerer and acquirer.

19. The method of claim 18, wherein step (d) includes alerting all acquirers to the existence of price-matched goods for offer.

20. The method of claim 19, which further includes promoting bidding among said buyers for said goods.

21. The method of 18, wherein step (d) includes alerting one or more offerers to the existence of price-matched acquirer requests, and allowing each of the one or more offerers to select those acquirers requests for which alerts should be given in step (d).

22. The method of 18, wherein step (d) includes alerting one or more acquires to the existence of price-matched offerer goods, and allowing each of the one or more acquires to select those offerers to whom alerts should be given in step (d).
